(19) United States
(12) Patent Application Publication
(10) Pub. No.: US 2026/0353182 A1
(43) Pub. Date: Nov. 5, 2026

(54) FIELD DESIGN FOR 60 GHZ PHYSICAL LAYER PROTOCOL DATA UNIT (PPDU) FORMAT

(71) Applicant: QUALCOMM Incorporated, San Diego, CA (US)

(72) Inventors: Lin YANG, San Diego, CA (US); Tzu-Hsuan CHOU, San Diego, CA (US); Bin TIAN, San Diego, CA (US); Youhan KIM, Saratoga, CA (US); Alecsander Petru EITAN, Haifa (IL)

(21) Appl. No.: 19/350,876

(22) Filed: Oct. 6, 2025

Related U.S. Application Data
(60) Provisional application No. 63/798,487, filed on May 1, 2025.

(51) Int. Cl. H04W 28/06

(52) U.S. Cl. CPC H04W 28/06

(57) ABSTRACT

This disclosure provides methods, components, devices and systems for field design for 60 GHz physical layer protocol data unit (PPDU) format. Some aspects more specifically relate to PPDU field contents and transmission of the PPDU. In some examples, the PPDU may include a preamble that includes two segments. The first segment of the preamble may include a legacy short training field (L-STF), a legacy long training field (L-LTF), a universal signal (U-SIG) field, and an integrated millimeter wave (IMMW) signal (SIG) field. The second segment of the preamble may include a STF field, one or more LTFs, an IMMW signal B (SIGB) field, a buffer symbol, or any combination thereof. The PPDU format may not include a legacy signal (L-SIG) field. The first segment of the preamble may be transmitted via one or more frequency domain duplicates (FD DUPs) from a base block (such as, a 64 tone base block).

### CROSS REFERENCES

The present Application for Patent claims benefit of U.S. Provisional Patent Application No. 63/798,487 by YANG et al., entitled “FIELD DESIGN FOR 60 GHZ PHYSICAL LAYER PROTOCOL DATA UNIT (PPDU) FORMAT,” filed May 1, 2025, assigned to the assignee hereof, and expressly incorporated herein.

### TECHNICAL FIELD

This disclosure relates generally to wireless communication and, more specifically, to field design for a physical layer protocol data unit (PPDU) format.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

Wireless devices may transmit physical layer protocol data units (PPDUs). PPDUs may include a preamble, and data. In some examples, wireless communications systems may support various frequency ranges, such as 60 GHz PPDU transmissions. However, some PPDU formats may not support transmissions via a 60 GHz band.

### SUMMARY

The systems, methods, and devices of this disclosure each have several innovative aspects, no single one of which is solely responsible for the desirable attributes disclosed herein.

An innovative aspect of the subject matter described in this disclosure can be implemented in a method for wireless communications by an apparatus. The method may include transmitting a physical layer protocol data unit (PPDU) that includes a preamble, the preamble including a first segment and a second segment, the first segment including one or more initial training fields, a universal signal (U-SIG) field and a first non-legacy signal (SIG) field (such as, an integrated millimeter wave (IMMW) SIG field), the U-SIG field immediately following the one or more initial training fields, the second segment including one or more short training fields (STFs), one or more long training fields (LTFs), or both, the U-SIG field indicating a PPDU type of the PPDU, and wherein the first non-legacy SIG field includes a set of parameters that corresponds to the PPDU type. In some cases, the second segment may optionally include a second non-legacy SIG field (such as an IMMW-SIGB field). In some examples, the second non-legacy SIG field may also include at least a portion of the set of parameters that corresponds to the PPDU type. In some cases, the PPDU may include, in addition to the preamble, a packet extension (PE) field, one or more training (TRN) fields, or both.

Another innovative aspect of the subject matter described in this disclosure can be implemented in an apparatus for wireless communications. The apparatus may include a processing system that includes processor circuitry and memory circuitry that stores code. The processing system may be configured to cause the apparatus to transmit a PPDU that includes a preamble, the preamble including a first segment and a second segment, the first segment including one or more initial training fields, a U-SIG field and a first non-legacy-SIG field, the U-SIG field immediately following the one or more initial training fields, the second segment including one or more STFs, one or more LTFs, or both, the U-SIG field indicating a PPDU type of the PPDU, and wherein the first non-legacy SIG field includes a set of parameters that corresponds to the PPDU type. In some cases, the second segment may optionally include a second non-legacy SIG field (such as an IMMW-SIGB field). In some examples, the second non-legacy SIG field may also include at least a portion of the set of parameters that corresponds to the PPDU type. In some cases, the PPDU may include, in addition to the preamble, a PE field, one or more training TRN fields, or both.

Another innovative aspect of the subject matter described in this disclosure can be implemented in an apparatus for wireless communications. The apparatus may include means for transmitting a PPDU that includes a preamble, the preamble including a first segment and a second segment, the first segment including one or more initial training fields, a U-SIG field and a first non-legacy-SIG field, the U-SIG field immediately following the one or more initial training fields, the second segment including one or more STFs, one or more LTFs, or both, the U-SIG field indicating a PPDU type of the PPDU, and wherein the first non-legacy SIG field includes a set of parameters that corresponds to the PPDU type. In some cases, the second segment may optionally include a second non-legacy SIG field (such as an IMMW-SIGB field). In some examples, the second non-legacy SIG field may also include at least a portion of the set of parameters that corresponds to the PPDU type. In some cases, the PPDU may include, in addition to the preamble, a PE field, one or more training TRN fields, or both.

Another innovative aspect of the subject matter described in this disclosure can be implemented in a non-transitory computer-readable medium storing code for wireless communications. The code may include instructions executable by one or more processors to transmit a PPDU that includes a preamble, the preamble including a first segment and a second segment, the first segment including one or more initial training fields, a U-SIG field and a first non-legacy-SIG field, the U-SIG field immediately following the one or more initial training fields, the second segment including one or more STFs, one or more LTFs, or both, the U-SIG field indicating a PPDU type of the PPDU, and wherein the first non-legacy SIG field includes a set of parameters that corresponds to the PPDU type. In some cases, the second segment may optionally include a second non-legacy SIG field (such as an IMMW-SIGB field). In some examples, the second non-legacy SIG field may also include at least a portion of the set of parameters that corresponds to the PPDU type. In some cases, the PPDU may include, in addition to the preamble, a PE field, one or more training TRN fields, or both.

In some examples of the method, apparatus, and non-transitory computer-readable medium described herein, the PPDU type includes a regular PPDU type and the set of parameters are indicated via a common field, a demodulation related field, and a data field, the common field indicating one or more of a station identifier, a cyclic redundancy check, a tail, a PE or TRN switch indicator, or a short interframe response field, and the demodulation related field indicating one or more of a guard interval and LTF field, an indication of a quantity of LTF symbols, an indication of whether the second non-legacy SIG field is present, a beamformed indication, a modulation and coding scheme field, a quantity of spatial streams, a low density parity check extra symbol segment, an indicator of low density parity check with a doubled code length, an unequal modulation indicator for a plurality of spatial streams, an additional modulation and coding scheme field for a plurality of spatial streams, or an interference mitigation indicator.

In some examples of the method, apparatus, and non-transitory computer-readable medium described herein, the PPDU type corresponds to data transmission and a beam refinement procedure (BRP), and the set of parameters are indicated via a common field, a demodulation related field, one or more BRP beam training related fields, and a data field, the common field indicating one or more of a station identifier, a cyclic redundancy check, a tail, a PE or TRN switch indicator, or a short interframe response field, the demodulation related field indicating one or more of a guard interval and LTF field, an indication of a quantity of LTF symbols, an indication of whether the second non-legacy SIG field is present, a beamformed indication, a modulation and coding scheme field, a quantity of spatial streams, a low density parity check extra symbol segment, an indicator of low density parity check with a doubled code length, an unequal modulation indicator for a plurality of spatial streams, an additional modulation and coding scheme field for a plurality of spatial streams, or an interference mitigation indicator, and the one or more BRP beam training fields indicating one or more of a training direction, a beam tracking request, a beam tracking request type, a quantity of transmit chains, a training length, a reception TRN-units per transmit TRN-unit, a TRN-unit P value, a TRN-unit M value, a TRN-unit N value, a TRN subfield sequence length, or a reception pattern in BRP transmission.

In some examples of the method, apparatus, and non-transitory computer-readable medium described herein, the PPDU type includes a beam refinement procedure (BRP) PPDU type and the set of parameters are indicated via a common field and one or more BRP beam training related fields, the common field indicating one or more of a station identifier, a cyclic redundancy check, a tail, a PE or TRN switch indicator, or a short interframe response field, and the one or more BRP beam training fields indicating one or more of a training direction, a beam tracking request, a beam tracking request type, a dual polarization TRN training indicator, a training length, a receiver TRN-units for each transmitter TRN-unit, a TRN-unit P value, a TRN-unit M value, a TRN-unit N value, a TRN subfield sequence length, or a reception pattern in BRP transmission.

In some examples of the method, apparatus, and non-transitory computer-readable medium described herein, the PPDU type corresponds to a sector sweep (SSW) PPDU type and the set of parameters are indicated via a common field and one or more SSW null data packet (NDP) related fields, the common field indicating one or more of a station identifier, a cyclic redundancy check, a tail, a PE or TRN switch indicator, or a short interframe response field, and the one or more SSW NDP related fields indicating one or more of a first training direction, a second training direction, an addressing mode, a multiple sector identifier capture indication, a training length, a count down, a radio frequency chain identifier, a sector identifier, an antenna identifier, a quantity of receive antennas or receive patterns, a list of sector identifiers selected, a list of antenna identifiers selected, a signal-to-noise ratio report, or a quantity of transmit chains.

In some examples of the method, apparatus, and non-transitory computer-readable medium described herein, the first segment further includes a legacy short training field (L-STF), a legacy long training field (L-LTF), or both.

In some examples of the method, apparatus, and non-transitory computer-readable medium described herein, a subcarrier spacing of the preamble may be 2.5 MHz, and a duration of the L-STF field may be 4 symbols.

In some examples of the method, apparatus, and non-transitory computer-readable medium described herein, a subcarrier spacing of the preamble may be 1.25 MHz, a duration of the L-STF field may be 2 symbols, and a tone plan of the L-STF includes populating one tone out of every eight tones in accordance with a carrier frequency offset (CFO) threshold.

In some examples of the method, apparatus, and non-transitory computer-readable medium described herein, the PPDU includes a null data packet (NDP), and the PPDU includes one LTF or one LTF plus one SIG symbol in which the one LTF may have a duration of 1 s for a single spatial stream, or includes a set of multiple LTFs that may have durations of 1 s for each respective spatial stream of a set of multiple spatial streams.

Another innovative aspect of the subject matter described in this disclosure can be implemented in a method for wireless communications by an apparatus. The method may include receiving a PPDU that includes, a preamble, the preamble including a first segment and a second segment, the first segment including one or more initial training fields, a U-SIG field and a first non-legacy SIG field, the U-SIG field immediately following the one or more initial training fields, the second segment including one or more STFs, one or more LTFs, or both, the U-SIG field indicating a PPDU type of the PPDU, and wherein the first non-legacy SIG field includes a set of parameters that corresponds to the PPDU type. In some cases, the second segment may optionally include a second non-legacy SIG field (such as an IMMW-SIGB field). In some examples, the second non-legacy SIG field may also include at least a portion of the set of parameters that corresponds to the PPDU type. In some cases, the PPDU may include, in addition to the preamble, a PE field, one or more training TRN fields, or both.

Another innovative aspect of the subject matter described in this disclosure can be implemented in an apparatus for wireless communications. The apparatus may include a processing system that includes processor circuitry and memory circuitry that stores code. The processing system may be configured to cause the apparatus to receive a PPDU that includes a preamble, the preamble including a first segment and a second segment, the first segment including one or more initial training fields, a U-SIG field and a first non-legacy SIG field, the U-SIG field immediately following the one or more initial training fields, the second segment including one or more STFs, one or more LTFs, or both, the U-SIG field indicating a PPDU type of the PPDU, and wherein the first non-legacy SIG field includes a set of parameters that corresponds to the PPDU type. In some cases, the second segment may optionally include a second non-legacy SIG field (such as an IMMW-SIGB field). In some examples, the second non-legacy SIG field may also include at least a portion of the set of parameters that corresponds to the PPDU type. In some cases, the PPDU may include, in addition to the preamble, a PE field, one or more training TRN fields, or both.

Another innovative aspect of the subject matter described in this disclosure can be implemented in an apparatus for wireless communications. The apparatus may include means for receiving a PPDU that includes a preamble, the preamble including a first segment and a second segment, the first segment including one or more initial training fields, a U-SIG field and a first non-legacy SIG field, the U-SIG field immediately following the one or more initial training fields, the second segment including one or more STFs, one or more LTFs, or both, the U-SIG field indicating a PPDU type of the PPDU, and wherein the first non-legacy SIG field includes a set of parameters that corresponds to the PPDU type. In some cases, the second segment may optionally include a second non-legacy SIG field (such as an IMMW-SIGB field). In some examples, the second non-legacy SIG field may also include at least a portion of the set of parameters that corresponds to the PPDU type. In some cases, the PPDU may include, in addition to the preamble, a PE field, one or more training TRN fields, or both.

Another innovative aspect of the subject matter described in this disclosure can be implemented in a non-transitory computer-readable medium storing code for wireless communications. The code may include instructions executable by one or more processors to receive a PPDU that includes a preamble, the preamble including a first segment and a second segment, the first segment including one or more initial training fields, a U-SIG field and a first non-legacy SIG field, the U-SIG field immediately following the one or more initial training fields, the second segment including one or more STFs, one or more LTFs, or both, the U-SIG field indicating a PPDU type of a the PPDU, and wherein the first non-legacy SIG field includes a set of parameters that corresponds to the PPDU type. In some cases, the second segment may optionally include a second non-legacy SIG field (such as an IMMW-SIGB field). In some examples, the second non-legacy SIG field may also include at least a portion of the set of parameters that corresponds to the PPDU type. In some cases, the PPDU may include, in addition to the preamble, a PE field, one or more training TRN fields, or both.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a frequency diagram depicting an example distributed tone mapping.

FIG. 5 shows a pictorial diagram of another example wireless communication network.

FIG. 6 shows an example field design of a PPDU format according to aspects of the present disclosure.

FIG. 7 shows an example of a signaling diagram that supports field design of a PPDU format according to aspects of the present disclosure.

FIG. 8 shows an example of a process flow that supports field design of a PPDU format according to aspects of the present disclosure.

FIG. 9 shows a block diagram of an example wireless communication device that supports field design of a PPDU format according to aspects of the present disclosure.

FIG. 10 shows an example method at a STA that supports field design of a PPDU format according to aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, wireless device may transmit wireless signaling via one or more physical layer (PHY) protocol data units (PPDUs). PPDUs may include one or more fields of preamble, data, and one or more additional fields. However, some PPDU formats may not be supported in some protocols, such as 60 GHz band protocols or other protocols from various IEEE 802.11 standards including future IEEE 802.11 standards.

Various aspects of the disclosure relate generally to PPDU formats, such as PPDU formats that may support communications in 60 GHz bands or other frequency bands (e.g., other frequency bands to be used by various IEEE 802.11 standards including future IEEE 802.11 standards). Some aspects more specifically relate to field design in such PPDU formats, beamforming procedures, encoding and processing, and transmission of such PPDUs. In some examples, the PPDU may include a preamble that includes two segments. The first segment of the preamble may include one or more training fields (e.g., a legacy short training field (L-STF), a legacy long training field (L-LTF), or both), a universal signal (U-SIG) field, and a first non-legacy signal (SIG) field (such as, an integrated millimeter wave (IMMW) signal (SIG) field). The second segment of the preamble may include one or more STF fields, one or more LTFs, or both. The second segment may optionally include a second non-legacy signal (SIG) field (such as, an IMMW SIGB field), a buffer symbol, or any combination thereof. The PPDU may also include a data field. The first segment and the second segment of the preamble, and the data field, may share a tone spacing (such as, a subcarrier spacing (SCS)), but the first and second segments of the preamble may be generated and transmitted according to different tone plans (such as, different tones may be populated) and different modulations. The PPDU may optionally further include one or more PE fields, one or more TRN fields, or both, which may, if present, also share the same tone spacing as the first segment and the second segment of the preamble and the data field. As used herein, the one or more TRN fields may sometimes also be referred to as “training fields” or “non-legacy training fields” and may be distinct from the legacy short training fields (L-STFs) and legacy long training fields (L-LTFs). For example, in some cases, the second segment of the preamble and the data may be beamformed, in which case the L-LTF of the first segment of the preamble may be used for channel estimation for the first segment of the preamble (such as, which is not beamformed or transmitted via a single stream), and multiple LTFs of the second sequence may be used for channel estimation of multiple beams or multiple streams.

Particular aspects of the subject matter described in this disclosure can be implemented to realize one or more of the following potential advantages. In some examples, transmission of a segmented PPDU preamble (e.g., a PPDU preamble with two segments) may enable a receiving device to independently process segments of the PPDU preamble. For example, the receiving device may process a first segment of the PPDU preamble containing a U-SIG field and a non-legacy SIG field independently and relatively earlier than a second segment of the PPDU preamble. The receiving device may extract PPDU configuration information from the first segment to configure processing parameters (e.g., demodulation schemes, buffer allocation, channel estimation algorithms) prior to processing the second segment, which may reduce processing latency and improve reception efficiency. In some examples, by transmitting a PPDU preamble with two segments having different tone plans, the PPDU may support channel estimation by the UE for the first segment of the preamble transmitted via a single spatial stream, and may also support channel estimation by a receiving device for the data which may be transmitted via multiple spatial streams. Thus, the two segments of the preamble may support more efficient and reliable reception and decoding of the preamble and the data at the receiving device. By maintaining the same tone spacing for the preamble and the data, efficient transmission of the preamble and the data may be achieved because a single tone spacing that improves phase noise performance for the data transmission may also be large enough to reduce overhead and small enough to satisfy a carrier frequency offset (CFO) threshold for the preamble. Further, by maintaining the same tone spacing between the first segment of the preamble and the second segment of the preamble (such as, for the L-LTF in the first segment of the preamble and the LTFs of the second segment of the preamble), the receiving device may perform more accurate channel estimation because common tones may be utilized across the two segments of the preamble. Additionally, or alternatively, by including the U-SIG field and the first non-legacy SIG field in the first segment of the preamble and, if present, the second non-legacy SIG field in the second segment of the preamble, channel estimation and decoding by the receiver may be improved, because the non-legacy SIG may be utilized flexibly to either include additional signaling information not included in the U-SIG field and the first non-legacy SIG field, or as a buffer symbol to ensure sufficient time by the receiver to perform channel estimation (such as, based on the one or more LTFs in the second segment of the preamble) or to prepare for decoding the data field. Although the preamble is described as having two segments, it may be understood that the two segments are introduced for brevity and simplicity of the examples provided herein. For example, various fields included in a segment of a preamble may refer to various fields included in the segment or various fields in a preamble without segmentation.

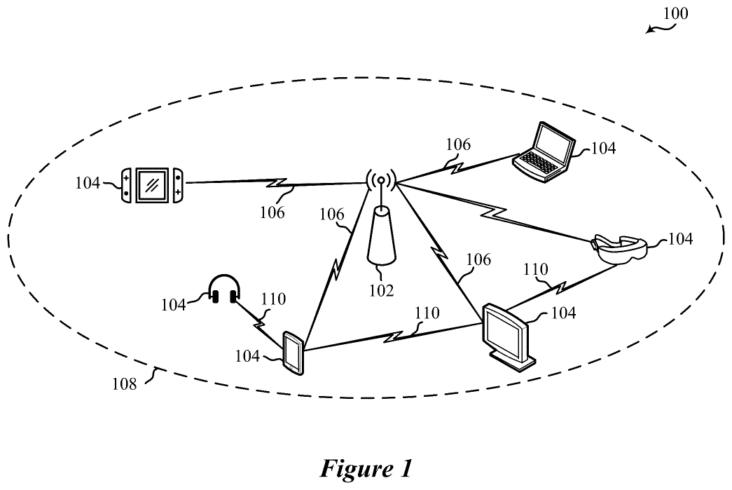

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, 60 GHz bands, or other suitable bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and optionally a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, 60 GHz bands, or other suitable bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (such as detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

In some wireless communication systems, wireless communication devices (such as an AP 102 and STAs 104 described with reference to FIG. 1) may operate via one or more wireless communication links in a frequency band higher than a sub-7 GHz (sub7, such as a 2.4 GHz frequency band, a 5 GHz frequency band, or a 6 GHz frequency band) frequency band. In some such wireless communication systems, the AP 102 and STAs 104 may communicate on a wireless communication link in a millimeter wave (“mmWave” or “mmW”) band (such as a frequency band between 30 GHz and 300 GHz, such as a 60 GHz frequency band). A wireless communication system supporting such mmWave communications (such as AP 102 and STAs 104 in wireless communication network 100) may use integrated mmWave (IMMW) techniques to support operations in these frequency bands. To manage the relatively high attenuation losses and other path losses associated with the mmWave band, the AP 102 and STAs 104 may transmit and receive directional communications via beamforming procedures. To select or otherwise generate directional beams in the mmWave band, a wireless communication device may perform beam sweeping, searching and training operations, which may involve various training and feedback reporting packet sequences. In some wireless communication systems, a mmWave link supports data communications while a sub7 link may be used for management and control information signaling to support the mmWave communications. For example, a STA 104 may first associate with an AP 102 to establish a sub7 link, and thereafter, perform beam searching and training in the mmWave band to establish a mmWave link for the communication of data. In such examples, the sub7 link may be referred to as an anchor link.

In addition to beam searching and training procedures, an AP 102 and a STA 104, after having selected a beam pair, may perform beam management and recovery procedures, including periodic beacon-based procedures and aperiodic STA-initiated fast link recovery procedures, which may involve the use of beam recovery sequences. The AP 102 and STAs 104 may use these beam management and recovery procedures for beam sync-up and identifying broken links. When communicating via a mmWave link, the AP 102 and STAs 104 may perform various channel access procedures including contention-based access procedures, target wake time (TWT)-based access procedures (including the use of dedicated and opportunistic service periods (SPs)), scheduled-mode access procedures, and triggered-mode access procedures. The APs 102 and STAs 104 operating in the mmWave band also may support various management frame optimizations and procedures including optimizations and procedures associated with discovery, scanning, association, roaming, link setup, updates and maintenance, and the initial and continuing configuration of BSS and link-specific parameters including channel selection and rate adaptation. To support or facilitate communication in the mmWave band, the APs 102 and STAs 104 also may make use of various PHY layer enhancements, such as additional bandwidth modes, numerologies, tone plans, preamble designs, codebook designs, waveform designs, new PPDU formats or reuse of existing sub-7 GHz PPDU formats for mmWave frequencies. Particular RF and analog designs, such as RF front end designs, antenna integration designs, and conversion architecture designs, may be implemented in APs 102 and STAs 104 to support mmWave operation.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QoS) parameters. For example, existing technology (such as IEEE 802.11ax standard amendment protocols) supports the use of up to 1024-quadrature amplitude modulation (QAM), where a modulated symbol carries 10 bits. To further improve peak data rate, each of the AP 102 or the STA 104 may employ use of 4096-QAM (also referred to as “4k QAM”), which enables a modulated symbol to carry 12 bits. 4k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 ρs per OFDM symbol). The AP 102 or the STA 104 using 4096-QAM may enable a 20% increase in data rate compared to 1024-QAM given the same coding rate, thereby allowing users to obtain higher transmission efficiency.

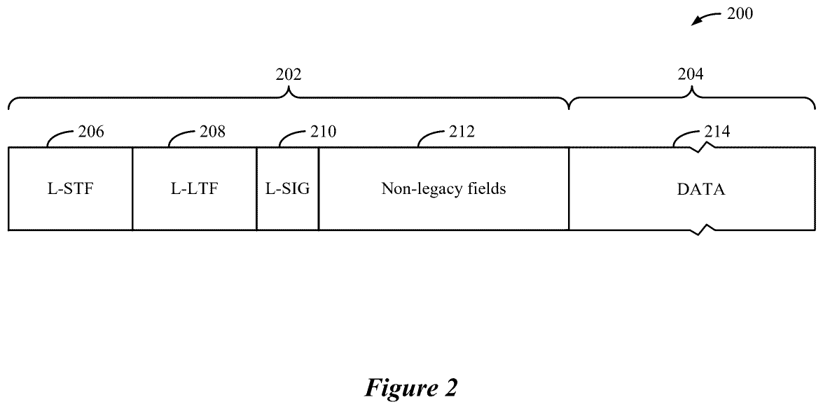

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

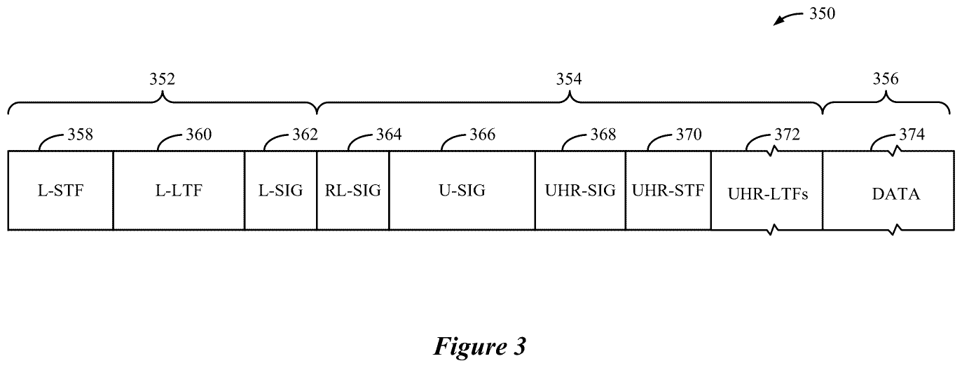

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (such as STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (such as a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (such as a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

APs and STAs (such as the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (such as in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (such as identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (such as one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

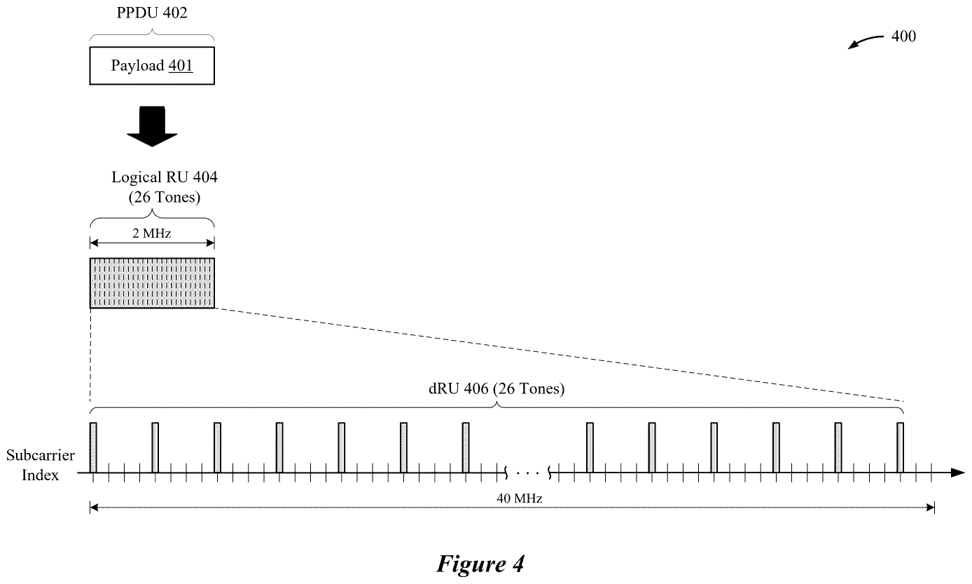

FIG. 4 shows a frequency diagram 400 depicting an example distributed tone mapping. More specifically, FIG. 4 shows an example mapping of how the tones of a payload 401 of a PPDU 402 are distributed for transmission over a spreading bandwidth of a wireless channel. In the illustrated example, the tones in a logical RU 404 (which may represent an rRU of non-distributed tones in accordance with a legacy tone plan) associated with payload 401 are mapped to a distributed RU (dRU) 406 in accordance with a distributed tone plan.

Aspects of the present disclosure recognize that by distributing the tones across a wider bandwidth, the per-tone transmit power of a logical RU 404 may be increased to provide greater flexibility in medium utilization for PSD-limited wireless channels. For example, when mapped to an rRU such as logical RU 404, the transmit power of the logical RU 404 may be severely limited based on the PSD of the wireless channel. For example, the LPI power class limits the transmit power of APs 102 and STAs 104 to 5 dBm/MHz and −1 dBm/MHz, respectively, in the 6 GHz band. As such, the per-tone transmit power of the logical RU 404 is limited by the number of tones mapped to each 1 MHz subchannel of the wireless channel.

By enabling a STA 104 to map modulation symbols in a distributed manner onto noncontiguous tones interspersed throughout all or a portion of a wireless channel, distributed transmissions may enable an increase in the per-tone transmit power used for each individual distributed tone, and thus the overall transmit power of the PPDU 402, without exceeding the PSD limits of the wireless channel. As shown in the example of FIG. 4, the STA 104 may map logical RU 404 to a set of 26 noncontiguous subcarrier indices spread across a 40 MHz wireless channel (also referred to herein as a “spreading bandwidth”). Compared to the tone mapping described above with respect to the legacy tone plan, the distributed tone mapping depicted in FIG. 4 effectively reduces the number of tones (of the logical RU 404) in each 1 MHz subchannel. For example, each of the 26 tones can be mapped to a different 1 MHz subchannel of the 40 MHz channel. As a result, each AP 102 or STA 104 implementing the distributed tone mapping of FIG. 4 can maximize its per-tone transmit power (which may maximize the overall transmit power of the logical RU 404).

In some examples (not shown in FIG. 4), multiple logical RUs may be mapped to interleaved subcarrier indices of a shared wireless channel. For example, a STA 104 may modulate a portion of the symbols on a number of tones representing multiple logical RUs to noncontiguous subcarrier indices associated with a shared wireless channel in accordance with a distributed tone plan. Furthermore, distributed transmissions by multiple STAs 104 may be multiplexed onto different sets of distributed tones of a shared wireless channel such as to enable an increase in the transmit power of each device without sacrificing spectral efficiency. Such increases in transmit power can be combined with some MCSs to increase the range and throughput of wireless communications on PSD-limited wireless channels. Distributed transmissions also may improve packet detection and channel estimation capabilities.

To support distributed transmissions, new packet designs and signaling may be used to indicate whether a PPDU 402 is transmitted on tones spanning an rRU, such as a logical RU 404 (according to a legacy tone plan), or a dRU 406 (according to a distributed tone plan). For example, the IEEE 802.11be standard amendment or earlier versions of the IEEE 802.11 family of wireless communication protocol standards define a trigger frame format which can be used to solicit the transmission of a trigger-based (TB) PPDU from one or more STAs 104. The trigger frame allocates resources to the STAs 104 for the transmission of the TB PPDU and indicates how the TB PPDU is to be configured for transmission. For example, the trigger frame may indicate a logical RU or MRU allocated for transmission in the TB PDDU. In some examples, the trigger frame may be further configured to carry tone distribution information indicating whether the logical RU (or MRU) maps to an rRU or a dRU.

In some implementations, a STA 104 may include a distributed tone mapper that maps the logical RU 404 to the dRU 406 in the frequency domain. The dRU 406 is converted to a time-domain signal (such as by an inverse fast Fourier transform (IFFT)) for transmission over a wireless channel. The AP 102 may receive the time-domain signal and reconstruct the dRU 406 (such as by a fast Fourier transform (FFT)). In some implementations, the AP 102 may include a distributed tone demapper that demaps the dRU 406 to the logical RU 404. In other words, the distributed tone demapper reverses the mapping performed by the distributed tone mapper at the STA 104. The AP 102 can recover the information carried (or modulated) on the logical RU 404 as a result of the demapping.

In the example of FIG. 4, the logical RU 404 is distributed evenly across the spreading bandwidth. While the example shown in FIG. 4 illustrates a spreading bandwidth of 40 MHz, spreading bandwidths also may include 80 MHz, 160 MHz, or 320 MHz. In some implementations, the logical RU 404 can be mapped to any suitable pattern of noncontiguous subcarrier indices. For example, in various implementations, the distance between any pair of adjacent modulated tones may be less than or greater than the distances depicted in FIG. 4.

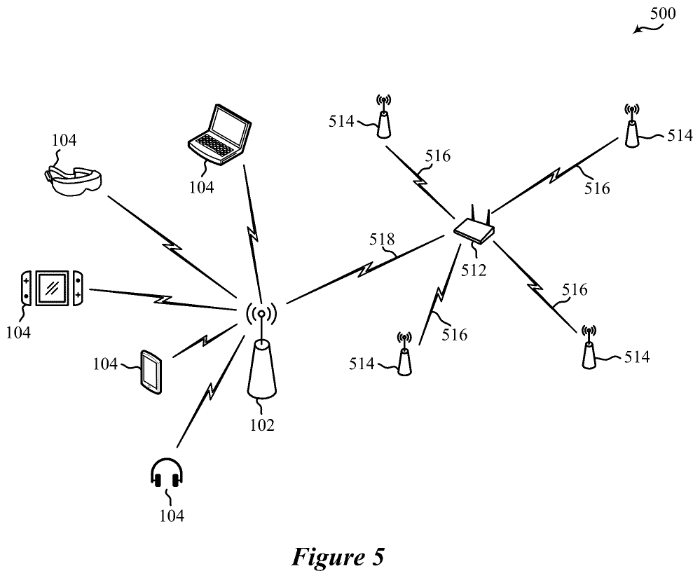

FIG. 5 shows a pictorial diagram of another example wireless communication network 500. According to some aspects, the wireless communication network 500 can be an example of a mesh network, an IoT network, or a sensor network in accordance with one or more of the IEEE 802.11 family of wireless communication protocol standards (including the 802.11ah amendment). The wireless communication network 500 may include multiple wireless communication devices 514, which in some implementations may include APs 102, STAs 104, or both. The wireless communication devices 514 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 514 sense, measure, collect or otherwise obtain and process data and transmit such raw or processed data to an intermediate device 512 for subsequent processing or distribution. Additionally, or alternatively, the intermediate device 512 may transmit control information, digital content (such as audio or video data), configuration information or other instructions to the wireless communication devices 514. The intermediate device 512 and the wireless communication devices 514 can communicate with one another via wireless communication links 516. In some examples, the wireless communication links 516 include Bluetooth links or other PAN or short-range communication links.

In some examples, the intermediate device 512 also may be configured for wireless communication with other networks such as with a WLAN or a wireless (such as cellular) wide area network (WWAN), which may, in turn, provide access to external networks including the Internet. For example, the intermediate device 512 may associate and communicate, over a Wi-Fi link 518, with an AP 102 of a wireless communication network 500, which also may serve various STAs 104. In some examples, the intermediate device 512 is an example of a network gateway, for example, an IoT gateway. In such a manner, the intermediate device 512 may serve as an edge network bridge providing a Wi-Fi core backhaul for the IoT network including the wireless communication devices 514. In some examples, the intermediate device 512 can analyze, preprocess and aggregate data received from the wireless communication devices 514 locally at the edge before transmitting it to other devices or external networks via the Wi-Fi link 518. The intermediate device 512 also can provide additional security for the IoT network and the data it transports.

Aspects of transmissions may vary according to a distance between a transmitter (such as an AP 102 or a STA 104) and a receiver (such as another AP 102 or STA 104). Wireless communication devices (such as the AP 102 or the STA 104) may generally benefit from having information regarding the location or proximities of the various STAs 104 within the coverage area. In some examples, relevant distances may be determined (such as calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

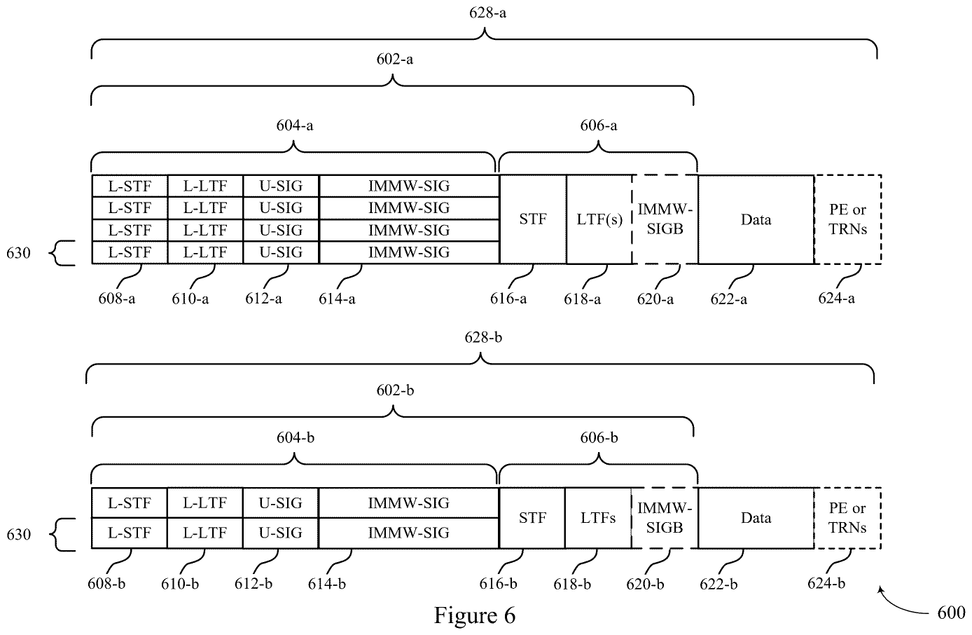

FIG. 6 shows an example field design 600 for a PPDU format according to aspects of the present disclosure. The field design 600 may implement, or be implemented by, aspects of the wireless communication network described with reference to FIG. 1, the PDU described with reference to FIG. 2, the PPDU described with reference to FIG. 3, the frequency diagram described with reference to FIG. 4, or the wireless communication network described with reference to FIG. 5. For example, a transmitting device (such as an AP 102, or a STA 104), which may be an example of a corresponding device described with reference to FIGS. 1-5, may send a PPDU such as a PPDU 628-a or a PPDU 628-b.

PPDU formats described herein may support wireless communications via a 60 GHz band and in accordance with corresponding protocols. In some examples, PPDUs 628 may support FD DUP in a preamble 602 (such as, a portion or segment of the preamble 602) and reception implementation (such as, at a receiving device) may support combination of FD DUP (such as up to 4 times duplication). In some examples, one or more SIG fields may support FD DUP patterns, and a preamble structure may support cross correlation with the L-LTF fields. In some examples, the PPDUs 628 may support power boosting from transmitting the preamble over a subband. In some examples, a length indication (such as an L_LEN indication) in an L-SIG or another SIG field may indicate a PPDU duration. In some examples, a buffer symbol (such as a SIGB field) may be used to carry some SIG information (such as SIG bits) by utilizing a two-segment SIG signaling structure, as described in greater detail herein.

The PPDU 628-a may be an example of a PPDU with a SCS of 1.25 MHz. The PPDU 628-a may include a preamble 602-a, data 622-a, and optionally one or more fields 624-a. The preamble 602-a may include a first segment 604-a and a second segment 606-a. The first segment 604-a may include one or more L-STF fields (referred to herein as L-STFs 608-a) or duplicates of an L-STF 608-a, one or more L-LTF fields (referred to herein as L-LTFs 610-a) or duplicates of an L-LTF 610-a, one or more U-SIG fields (referred to herein as U-SIGs 612-a) or duplicates of a U-SIG 612-a, and one or more first non-legacy-SIG fields 614-a such as IMMW-SIG fields (referred to herein as non-legacy-SIGs 614-a) or duplicates of an non-legacy-SIG 614-a. The second segment 606-a of the preamble 602-a may include one or more of an STF field (there may be a single STF field or multiple STF fields, referred to herein as an STF 616-a), one or multiple LTF fields (referred to herein as LTFs 618-a), and a second non-legacy-SIG field, such as an IMMW SIGB field (referred to herein as an IMMW-SIGB 620-a, or a buffer symbol). In some cases, the second non-legacy-SIG field may be omitted from the second segment 606-a of the preamble 602-a (e.g., the second non-legacy-SIG field may be optional, for example if sufficient signaling information is provided by the U-SIG field and the first non-legacy SIG field, or if the PPDU is a null data packet (NDP) that does not include additional signaling parameters for data demodulation). The one or more optional fields 624-a may include a PE field (referred to herein as a PE), one or more TRN fields (referred to herein as TRNs), or both.

The PPDU 628-b may be an example of a PPDU with a SCS of 2.5 MHz. The PPDU 628-b may include a preamble 602-b, data 622-b, and optionally one or more fields 624-b. The preamble 602-b may include a first segment 604-b and a second segment 606-b. The first segment 604-b may include one or more L-STF fields (referred to herein as L-STFs 608-b) or duplicates of an L-STF 608-b, one or more L-LTF fields (referred to herein as L-LTFs 610-b) or duplicates of an L-LTF 610-b, one or more U-SIG fields (referred to herein as a U-SIGs 612-b) or duplicates of a U-SIG 612-b, and one or more first non-legacy-SIG fields 614-b such as IMMW-SIG fields (referred to herein as IMMW-SIGs 614-b) or duplicates of a first non-legacy-SIG 614-b. The second segment 606-b of the preamble 602-b may include one or more of an STF field (referred to herein as an STF 616-b), one or multiple LTF fields (referred to herein as LTFs 618-b), and a second non-legacy-SIG field such as an IMMW-SIGB field (referred to herein as an non-legacy-SIGB 620-b, or a buffer symbol). In some cases, the second non-legacy-SIG field may be omitted from the second segment 606-b of the preamble 602-b (e.g., the second non-legacy-SIG field may be optional). The one or more optional fields 624-b may include a PE field (referred to herein as a PE), one or more TRN fields (referred to herein as TRNs), or both.

As described herein, any of the fields in a PPDU 628 may refer to a similar or corresponding field in any PPDU format (such as an L-STF 608 may refer to an L-STF 608-a, or an L-STF 608-b, or another L-STF 608 in another PPDU having a different subcarrier spacing (SCS)).

A PPDU 628 may not include an L-SIG field. Instead, signal information may be conveyed via the U-SIG 612, the first non-legacy-SIG 614, the second non-legacy-SIG 620, or any combination thereof. For example, instead of joint encoding an L-SIG field and one or more additional SIG fields within a preamble, techniques described herein may support a first segment of the preamble including the U-SIG field and the first non-legacy SIG field which may be individually encoded, and a second segment of the preamble which may include a second non-legacy SIG field. The second non-legacy SIG field in the second field may include additional signaling information (in addition to the U-SIG field and the non-legacy SIG field), or may serve as a buffering symbol sufficient for channel estimation or demodulation by a receiving device.

In some examples (such as, for larger bandwidth modes, such as for a 640 MHz bandwidth), the first segment 604 of the preamble 602 may be formed by FD duplications based on a base block 630 (such as a 64 tone block or a smallest allowed BW block). For example, a 1280 MHz PPDU may support 16× FD duplication for an SCS of 1.25 MHz, or 8× FD duplication for an SCS of 2.5 MHz. The second segment 606 of the preamble 602, the data 622, and the contents of the field or fields 624 may not be duplicated across the available bandwidth.

In some examples, instead of a two-segment preamble, a single-segment preamble 602 may be supported. In such examples, the second segment 606 may be omitted from the PPDU 628.

In some examples, the transmitting device may support a single transmission stream (such as, a single spatial stream). In such examples, the transmitting device may perform analog beam forming over the entire PPDU 628 (such as, from the L-STF 608 to the field or fields 624). In such examples, functionality of the STF 616 may be redundant or may not be needed. However, the PPDU 628 may include the STF 616, which may be utilized as padding to provide sufficient processing time between SIG decoding and LTF processing (by the receiving device). The L-LTF 610 and the LTF 618 may be transmitted in accordance with different tone plans (such as, in the case of channel estimation based on the L-LTF 610 for data 622). In such examples, additional interpolation may be relied upon, in which case the LTF field used for channel estimation for data demodulation may be beneficial.

In some examples, the transmitting device may support multiple spatial streams (such as, Nₛₛ>1) or MIMO transmission (such as, through analog beam forming or hybrid beamforming). In such examples, the preamble content of the first segment 604 may be duplicated over all transmission chains with application of per chain cyclic shift delay (CSD) (such as, if the L-LTF 610 has a 2 symbol duration (as supported in other protocols, such as legacy PPDUs). In some examples, different data may be transmitted via different spatial streams (with or without digital precoding), in which case MIMO channel estimation (such as, at the receiving device) may be based on the presence of the STF 616 and the one or more LTFs 618. For example, the STF 616 and the LTFs 618 may span the available bandwidth (such as, may not be duplicated like the first segment 604), and the receiving device may perform channel estimation using the LTFs 618.

In some examples, a same tone spacing may be utilized for the preamble 602 and the data 622. Data tone spacing may be based on (such as, limited by) phase noise performance. Preamble tone spacing may be based on (such as, limited by) CFO estimation for the L-STF 608. If the SCS is too small, then a CFO pull-in range may not be large enough, resulting in performance degradation. However, if the SCS is too large, then the L-STF 608 may have a duration that is too small to cover AGC gain settling. A preamble processing time for a smaller SCS and a longer symbol duration may provide an improved processing time margin. L-LTF 610 and the LTF 618 may be transmitted in accordance with a same tone spacing, which may improve channel estimation at the receiving device and may result in overhead reduction.

The transmitting device may transmit the PPDU 628 using a same tone plan and a same numerology for the preamble 602 and the data 622. In some examples, a cyclic prefix, or a duration corresponding to a cyclic prefix (CP), may be different for the preamble 602 and the data 622. In some examples (such as, for a 256 FFT), one SIG symbol may be sufficient to carry all signaling information. In such examples, for one spatial stream (such as, if Nₛₛ=1), the STF 616 and the LTF 618 may be skipped (such as nulled or omitted from the PPDU 628). In such examples, the CP for the data 622 may be shrunk (such as, decreased).

In some examples, a greenfield frame format may be utilized, in which case a PPDU may include the L-STF 608, L-LTF 610, one or more SIG fields, the LTF 618, and data 622. For example, the transmitting device may perform common transmission of the L-STF 608, L-LTF 610, and the SIG, and may perform per stream beamforming for the LTFs 618 and data 622. For example, the transmitting device may apply per chain CSD and different data and P-matrix orthogonalized LTFs 618 may be transmitted on a per transmit chain basis. In some examples, the STF 616, LTFs 618, and SIG information and data may be transmitted on a per spatial stream basis.

The L-STF 608 may be defined to support packet detection and AGC settings, as well as CFO threshold. For example, the PPDU 628-a in accordance with an SCS of 2.5 MHz, a duration of the L-STF may be at least 2 μs. Such a duration of the L-STF 608 may support packet detection and AGC setting. Thus, for SCS of 2.5 MHz, the L-STF 608 may have a duration of 4 symbols. An L-STF sequence corresponding to another band or another protocol may be utilized for the L-STF 608. If the SCS is less than or equal to 1.25 MHz, the L-STF 608 may utilize a tone plan in which every eighth tone (such as, instead of every fourth tone). For example, such a tone plan (such as, for a 64 FFT) may satisfy a CFO threshold (such as the CFO may satisfy a pull-in range for the signal). An STF sequence may be applied to the L-STF 608. The sequence may satisfy a peak to power average ratio (PAPR) threshold (such as a PAPR of 2.2303 dB). The sequence may define values applied to the tone plan of the L-STF 608. For example, a first sequence for the L-STF 608 may be defined as

$$[ 1 , 1 , 1 , - 1 , 1 , - 1 ] * \frac{1 + j}{\sqrt{2}}$$

populated on tones of −24, −16, −8, 8, 16, and 24, where the other tones are zeroes. In another example, the sequence for the L-STF 608 may be defined as

$$[ 1 , - 1 , 1 , - 1 , - 1 , - 1 ] * \frac{1 + j}{\sqrt{2}} ,$$

populated on the tones of −24, −16, −8, 8, 16, and 24, where the other tones are zeroes. Such an L-STF 608 (with every eighty tone populated) may have a duration of 2 symbols.

The L-LTF 610 may be transmitted according to an upclocking procedure (such as, in accordance with scalable digital processing). The L-LTF 610 may be transmitted according to an FD duplication pattern and using a sequence that is supported by one or more additional protocols. In some examples, the PPDU format may support a double L-LTF symbol for time domain processing. MIMO transmissions may be initiated at the second segment 606 (such as, for the STF 616, the LTF 618, the second non-legacy-SIG 620, the data 622, and the fields 624). The same preamble content of the first segment 604 (such as, from the L-STF 608 to the non-legacy-SIG 614) may be transmitted via multiple streams or transmit chains and a per chain CSD may be applied. The L-LTF 610 may provide channel estimation for the U-SIG 612 and the non-legacy-SIG 614 for single stream transmissions. The LTF 618 may provide MIMO channel estimation for data demodulation of multiple streams.

In some examples, the L-LTF 610 and LTF 618 may utilize a different tone plan. The L-LTF 610 may be transmitted such that populated tones in each 64 point FFT, and the tone plan may be duplicated over the PPDU bandwidth. However, the LTF 618 may be designed with a tone plan for the full PPDU bandwidth. For single stream transmissions, if the LTF 618 is turned off (such as, to turn off the LTF 618) by using channel estimation from the L-LTF 610 for the data 622, the receiver may perform channel interpolation, which could lead to performance loss. A wireless device may interpolate on 11 edge tones across a channel boundary (such as a 64 tone 20 MHz channel boundary). In some examples, a wireless device may interpolate a missing channel estimate on sub-direct current (DC) tones and additional tones used in the tone plan of the PPDU bandwidth but not in the duplicated 64 FFT tone plan. For multiple stream transmissions, the L-LTF 610 may support one stream channel that is different from the LTF 618, which may result in a different channel estimation.

The PPDU 628 may support different tone plans and channel estimation via the L-LTF 610, the LTF, or both. In some examples, the PPDU 628 may include two segments of the preamble 602, the LTF 618 may be included (such as, may not be turned off), and channel estimation combining may not be supported. The L-LTF 610 may provide channel estimation for the SIG fields, but the LTFs 618 may provide channel estimation for the data 622. In some examples, for the L-LTF 610 with duplication, the transmitting device may fill in some non-zero values on edge tones across subband boundaries. If the filler tones have the same value in each 20 MHz channel, then a processing system based on 20 MHz channels may be utilized (such as, the initial timing estimation at an FFT symbol boundary may be based on per 20 MHz L-STF 608 and L-LTF 610). Such a patching approach may lead to a higher LTF PAPR. Such a patching approach may be applicable, for example, to a single spatial stream (such as, Nₛₛ=1) and an applied P matrix (a square matrix which orthogonalizes LTFs) may rely on the same LTF values for the first spatial stream and other spatial streams. In some examples, for an L-LTF 610 with duplication, the L-LTFs may be replaced with a full bandwidth LTF. The full bandwidth LTF may satisfy a PAPR threshold. In some examples, to avoid a large phase drift, which may degrade or destroy orthogonality from using a P matrix. In such examples, a P matrix may be applied to 2 LTF symbols prior to a SIG field. Such techniques may be applied for Nₛₛ=1 and Nₛₛ=2. The P matrix may result in 2 LTF symbols that are not identical. Each LTF symbol may correspond to its own CP, to maintain (such as, keep) the circular convolution property. Similar to the L-LTF 610 structure (such as, a doble GI (DGI) and an L-LTF and an L-LTF) the double GI may be included at the front of the LTF 618 to address time uncertainty, followed by a single GI in an additional LTF symbol, where both of the LTF symbols are P matrix masked LTF symbols (such as, a DGI, an LTF symbol, a GI, and an LTF symbol).

The LTF 618 and the STF 616 may be included in the PPDU (such as, in a single segment structure or in a two-segment structure). The STF 616 and the LTF 618 may support single stream or multi-stream transmissions. For the single stream case, the L-LTF 610 and the LTF 618 may correspond to different tone plans (and the two-segment PPDU format may support a simple channel estimation procedure). For more than one spatial stream, the LTF 618 may support MIMO channel estimation. In such examples, the L-LTF 610 may not support MIMO channel estimation unless the L-LTF 610 is modified to separate channel estimation, which may be inefficient or may not be backwards compatible. In some examples, the STF 616 sequence and the LTF 618 sequence may be defined according to a given tone plan, and the STF and LTF may have the same tone plan as the data 622.

In some examples, a PPDU may be an example of an NDP. Such an NDP frame design may use or be an example of a degraded control PHY (CPHY) PPDU. Such an NDP may support both one dimensional and two dimensional scanning. Such a PPDU may rely on level 3 (L3) PHY coupling between various links or protocols (such as, L3 PHY coupling between sub7 GHz and 60 GHz links). The CPHY duration may be 1 μs (such as, in a sector-level sweep (SLS) stage, plus one μs per each TRN subfield for each antenna element or each sector in a receiver beam refinement procedure (BRP). In some examples, such a PPDU may include only a very short training sequence for signal measurement (such as, the LTF may have a duration of 1 μs). In some examples, the PPDU may also include a short beam message and may report beam training feedback information (such as the LTF may have a duration of 1 μs, and a SIG field may have a duration of 1 μs).

In some examples, a beam search process and link schedules may be configured by sub7 GHz link, which may provide an initial timing and frequency reference. If beam search is performed for multiple streams, then more LTFs 618 may be included in the PPDU in each training NDP. A quantity of LTFs (N_{LTF}) may be greater than or equal to a quantity of spatial streams (N_{SS}) (such as, N_{LTF}≥N_{SS}).

For a training sequence in a degraded CPHY PPDU, a time domain Golay sequence may be used to simplify packet detection. For example, for multi-stream beam searching, the transmitting device may generate multiple orthogonal sequences for each LTF (such as, one orthogonal sequence for each stream) to transmit simultaneously. Such unified designs may be used for various sequences used in some bands (such as, 60 GHz bands).

The data field of the PPDU (the data 622) may be generated and transmitted in accordance with a tone plan. The tone plan may be defined for the smallest allowed bandwidth (such as, for a block 630, a channel, a subchannel), and may then be duplicated across a wide bandwidth. In some examples, a tone plan may be independently defined in each bandwidth, and the defined tone plans may utilize upclocking techniques. For example, a non-duplicated tone plan may be defined for a 128 point FFT, a 1024 point FFT, and so on.

In some examples, the transmitting device may perform segment parsing and per segment processing across a band or bandwidth. For example, the transmitting device may perform 80 MHz segment parsing in sub7 GHz bands and upclocking. For instance, for a SCS of 1.25 MHz, the device may perform segment parsing and per segment processing from 640 MHz and above. In some examples, for a SCS of 2.5 MHz, the device may perform segment parsing and per segment processing from 1280 MHz and above. In some examples, the upclocking may be based on a tone plan for which no segment parsing is needed. In such examples, for an SCS of 1.25, the device may perform segment parsing and per segment processing for 2560 MHz and above. For an SCS of 2.5 MHz, the device may perform segment parsing and per segment processing for 5120 MHz and above.

In some examples, the PPDU 628 may include a PE, one or more TRNs, or both (such as in one or more fields 624). For example, the PE may be utilized for wide bandwidth operations. The TRN may be used for OTA beam refinement while transmitting data 622. The PE, the TRN, or both, may therefore be utilized in some situations, but one of the PE and the TRN may be more important or valuable than the other, or may have a higher priority. Thus, flexibility in the inclusion of the PE and the TRNs may improve efficiency and effectiveness of beam refinement, data throughput, and wideband communications. In some examples, the PE may be included at the end of each packet (such as, at the end of each PPDU according to the PPDU format described herein). The TRN may or may not be present in the PPDU 628. In such examples, a value in a SIG field may indicate whether the TRN is present or not. For example, whether the TRN is present or not may depend on a TRN-length field in a SIG field (such as, the U-SIG 612, the first non-legacy-SIG 614, the second non-legacy-SIG). If the TRN-length field in the SIG is equal to 0, or if some other indication is present (such as, a beam tracking request equals one and a training direction is set for reception training), then the TRN may not be present in the PPDU.

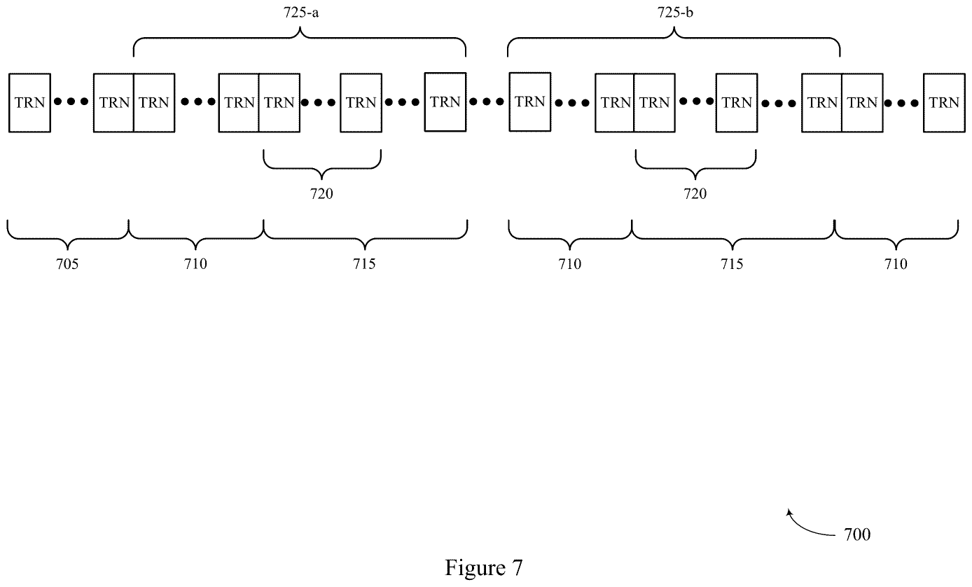

In some examples, only one of the PE and the TRNs may be included in the PPDU. In some examples, either the PE or the TRN may be the last field of the PPDU. Whether the PE or the TRN is the last field in the PPDU may be indicated by a SIG field. For example, a dedicated signaling bit in a SIG field (such as, the U-SIG 612, the first non-legacy-SIG 614, the second non-legacy-SIG) may indicate whether the PE or the TRN is the last field of the PPDU. In some examples, whether the PE or the TRN is the last field of the PPDU may be indicated by a TRN-length field in a SIG field (such as, whether the TRN-length field in the SIG is set to 0). For instance, if the TRN-length is equal to 0, or some other indication is present such as a beam tracking request equals one and a training direction is set for reception training, then the last field in the SIG may be the PE. If the TRN-length field in the SIG is greater than 0 (such as, is not equal to 0) and/or if some other indication such as a beam tracking request equals zero or a training direction is set for transmit training, then the ending packing may be the TRN. TRN structure and sequence are described in greater detail with reference to FIG. 7.

In some examples, a data PHY (DPHY) PPDU format without any data may be used as an NDP for beam training. In such examples, the second non-legacy SIG field may not be utilized for NDP transmissions, and one or more SIG fields (such as, the U-SIG 612, the non-legacy-SIG 614) may be simplified for NDP transmissions. In some examples, such an NDP PPDU may be used in two dimensional searching, as an SLS frame, as a BRP frame, or the like. For single input single out output (SISO) transmissions, the LTF 618 with repetitions may be used as TRN field in a BRP frame. For example, the NDP PPDU may include an L-STF, an L-LTF, one or more SIG fields, an STF, and an LTF with repetition with or without a PE field. Similar to TRN field designs (such as the designs described with reference to FIG. 7), not all LTF symbols repeated may be used for beam forming training, and some LTF symbols may be utilized for transition and phase tracking purposes.

The PPDU 628 may include a second non-legacy-SIG field, or a buffer symbol. In some examples, the second non-legacy-SIG 620 may be allocated between the LTF 618 and the data 622, which may provide enough time to prepare channel estimation and other demodulation parameters (such as, at the receiving device). The second non-legacy-SIG 620 may carry part of the signaling information as a SIGB field. In some examples, an indication of SIGB presence may be included in the first non-legacy-SIG 614. In some examples, the PPDU may include a dummy symbol (a buffer symbol, instead of a SIGB field). The second non-legacy-SIG 620 may be a buffer symbol, or may carry information that is not immediately needed for the following data demodulation, and may therefore also serve as a buffer symbol. For example, instead of a SIG information, the second non-legacy-SIG 620 (or a similar buffer symbol) may include additional LTF symbols for beam synchronization, BRP training, or interference measurements, among other examples.

The PPDU may include one or more multiple SIG fields (such as, the U-SIG 612, the first non-legacy-SIG 614, and the second non-legacy-SIG or buffer symbols). The U-SIG 612 may include one or more version independent fields, such as a PHY version identifier, BSS color information, TXOP information, direction information (such as, downlink or uplink), bandwidth information, device identifiers (such as a STA ID), a length field, or the like. The length field may be included in the U-SIG 612 (such as, instead of in an L-SIG field which may not be included in the PPDU 628), and may indicate a duration of the PPDU 628. The U-SIG 612 also may include version dependent fields, indicating information such as a PPDU type. The U-SIG 612, the first non-legacy-SIG 614, and the second non-legacy-SIG may carry data demodulation related information (such as, if the PPDU is not an NDP PPDU). The U-SIG 612, the first non-legacy-SIG 614, and the second non-legacy-SIG may carry beam forming training information, beam refinement information, beam management information, or the like (such as, if the PPDU is not a pure data PPDU).

The transmitting device may perform separate encoding of the U-SIG 612 and the non-legacy-SIG 614. The transmitting device may perform modulation on both the U-SIG 612 and the non-legacy-SIG 614. For example, both the U-SIG 612 and the non-legacy-SIG 614 may be BPSK modulated. In some examples (such as, to indicate different PPDU formats), some SIG symbols (such as, the U-SIG symbols) may be QBPSK modulated (such as, to indicate an ELR PPDU format).

The U-SIG 612 may include one or more version independent fields (such as with a total of 54 bits). The U-SIG 612 may include a PHY version ID field (3 bits), a bandwidth field (1 or 2 bits), a STA ID field (11 bits) (or the STA ID may be included in the non-legacy-SIG 614), a length field (13 or 14 bits), a CRC field (4 bits), a tail field (6 bits), or any combination thereof. The length field may define a quantity of data symbols in the PSDU. A threshold packet duration may be, for instance, 5464 μs, with 4× upclocking (such as, a 1 μs symbol duration), and the length field may use 13 bits. Or, with 8× upclocking, the length field may include 14 bits. Because the non-legacy transmission is scheduled and both transmission and receptions are directional, the U-SIG 612 may, or may not, include a BSS color field (6 bits), a TXOP field (7 bits), and a downlink/uplink field (1 bit).

The U-SIG 612 may include one or more version dependent fields (such as with 3 bits). The U-SIG 612 may indicate a PPDU type of a set of candidate PPDU types. For example, the U-SIG 612 may include a PPDU type field (3 bits). The PPDU type field may indicate a regular data PPDU (such as, with 2 symbols for the non-legacy-SIG 614), an ELR PPDU type, a Data+BRP-Tx/BRP-Rx/BRP-Tx/Rx type, a BRP type (regular NDP doing BRP) PPDU (in which case the PPDU does not include a data field), an sector sweep (SSW) type (a regular NDP doing SSW) PPDU (in which case the PPDU does not include a data field), or a triggered NDP sounding PPDU (in which case there is no IMW-SIG or SIGB field, and no data field in the PPDU). In some examples (such as, for a 64 point FFT), the U-SIG 612 may have a duration of 3 symbols, or if the STA ID is included in the non-legacy-SIG, the U-SIG 612 may have a duration of 2 symbols.

The first non-legacy-SIG 614, or the second non-legacy-SIG 620, or both, may include various fields for a data PPDU. For example, the non-legacy-SIG 614 may include one or more common fields (with a total of 23 bits). The common field may include a STA ID (11 bits, or the STA ID may be included in the version independent fields of the U-SIG 612), a CRC (4 bits), a tail (6 bits), and a PE/TRN switch indicator (1 bit), and a short interframe (SIF) response field (1 bit). One of the first non-legacy-SIG 614 and the second non-legacy-SIG 620 may include a demodulation related field (with a total of 20 bits). The demodulation related field may include a GI and LTF field (2 bits), an indication of a quantity of LTF symbols (3 bits), an indication of whether the second non-legacy SIG is present (1 bit), a beamformed indication (1 bit), an MCS field (5 bits), a quantity of spatial streams (2 bits), an LDPC extra symbol segment (1 bit), a 2×LDPC indicator (1 bit), and a unequal modulation (UEQM) indicator (3 bits) for more than one spatial streams (otherwise, the 3 bits may be reserved), and an interference mitigation indicator (1 bit). The UEQM indicator may not be included due to short distance and small delay spreads in 60 GHz band, or different UEQM patterns may be utilized. In some examples, the 3 bits may be replaced by individual MCSs for each stream. The second non-legacy SIG may carry per user information. The data PPDU may include a data field that carries higher layer data, which may be in the form of MPDUs or an A-MPDU. The data field may indicate, such as within the MPDUs, parameters such as respective MPDU lengths, sequence numbers, Frame Control Fields, Frame Check Sequences, and MAC addresses for each MPDU.

In some examples, a PPDU may be for data transmission and for BRP. In such examples, the first non-legacy-SIG 614, the second non-legacy-SIG 620, or both, may carry the common field, the demodulation related field, and BRP beam training related fields (such as, with a total of 34 bits). For example, one of the SIG fields may include a training direction (2 bits for transmit, receive, and transmit/receive), a beam tracking request (1 bit), a beam tracking request type (1 bit for analog or baseband training, which may support MIMO), a number of transmit chains (2 bits, for MIMO support), a training length (8 bits), a reception TRN-units per transmit TRN-unit (8 bits), a TRN-unit P value (2 bits), a TRN-unit M value (4 bits), a TRN-unit N value (2 bits), a TRN subfield sequence length (2 bits), and a reception pattern in BRP transmission (1 bit for quasi-omni/directional antenna weight vectors (AWVs). The PPDU may include a data field that carries higher layer data, which may be in the form of MPDUs or an A-MPDU. The data field may indicate, such as within the MPDUs, parameters such as respective MPDU lengths, sequence numbers, Frame Control Fields, Frame Check Sequences, and MAC addresses for each MPDU.

For a BRP NDP PPDU, the first non-legacy-SIG, the second non-legacy-SIG, or both, may include a common field (with a total of 23 bits) as described herein, and BRP beam training related field (with a total of 34 bits). The beam training related field may include a training direction (2 bits for transmitter, receiver, and transmitter/receiver), a beam tracking request (1 bit), a beam tracking request type (1 bit for analog or baseband training, which may support MIMO), a dual polarization TRN training indicator (1 bit for MIMO support), a training length (8 bits), a receiver TRN-units for each transmitter TRN-unit (8 bits), a TRN-unit P value (2 bits), a TRN-unit M value (4 bits), a TRN-unit N value (2 bits), a TRN subfield sequence length (2 bits), and a reception pattern in BRP transmission (1 bit for quasi-omni/directional AWV).

In some example, the PPDU may be an SSW NDP PPDU. In such examples, the first non-legacy-SIG, the second non-legacy-SIG, or both, may include a common field (with 23 total bits as described herein), and an SSW NDP related fields (such as, a total of 57 bits or 89 bits). The SSW NDP related field may include a training direction 1 (1 bit for initiator or responder), a training direction 2 (1 bit for the transmit training or receive training), an addressing mode (1 bit for unicast or broadcast), an MIDC indication (1 bit for a multiple sector ID capture), a training length (8 bits), a count down (11 bits), a radio frequency (RF) chain ID (2 bits), a sector ID (6 bits), an antenna ID (2 bits), a number of receive antennas or receive patterns (6 bits), a list of sector IDs selected (6 or 6*3 bits), a list of antenna IDs selected (2 or 2*3 bits), an SNR report (8 or 8*3 bits), and a number of transmit chains (2 bits).

FIG. 7 shows an example of a signaling diagram 700 that supports field design for 60 GHz PPDU format. The signaling diagram 700 may implement, or be implemented by, aspects of the wireless communication network described with reference to FIG. 1, the PDU described with reference to FIG. 2, the PPDU described with reference to FIG. 3, the frequency diagram described with reference to FIG. 4, the wireless communication network described with reference to FIG. 5, or the signaling diagram described with reference to FIG. 6. For example, a transmitting device (such as an AP 102, or a STA 104), which may be an example of a corresponding device described with reference to FIGS. 1-6, may send a PPDU such as a PPDU 628-a or a PPDU 628-b, or any of the other PPDUs described with reference to FIG. 6.

The PPDU may include one or more TRN fields. The transmitting device may transmit one or more TRNs in accordance with a TRN structure and a TRN sequence. The TRN may be generated per chain. The transmitting device may refrain from performing per chain CSD (such as, no per chain CSD may be applied to the TRNs). The TRN structure may accommodate BRP transmit training, BRP joint transmit and receive training, and BRP receive training, as well as antennas with dual polarization. Each TRN subfield (of a TRN field such as the field 624) may include one TRN sequence in a SISO training, or a set of orthogonal TRN sequences in a MIMO training.

TRN fields (such as, via TRN subfields) may be defined by one or more parameters, such as a T value (such as, a transition interval), a P value (such as, a number of TRN subfields in a TRN unit for a channel estimation and phase tracking, which may correspond to a same AWV as the preamble or data or both), an M value (such as, a number of TRN subfields in a TRN unit for beamforming training, which may correspond to the same or may be different than an AWV for the preamble or data), and an N value (such as, a number of TRN subfields in a TRN unit during which a different AWV than a transmission AWV for preamble may be used for transmit beam training, a transmission and reception polarization may change at the end of each N/2 TRNs, if requested). Each of the parameter values may indicate a duration during which a set or quantity of TRNs subfields are transmitted. For example, during a duration 705 (prior to a TRN unit 725-a) the transmitting device may transmit T repetitions of the TRN subfield (the duration 705 may be a transition interval prior to a next TRN unit 725-a). During the TRN unit 725, the device may transmit P repetitions of the TRN subfield during the duration 710 (such as, for channel estimation and synchronization). The device may transmit M repetitions of the TRN subfield during the duration 715 (for beam forming training). The device may transmit N repetitions of the TRN subfield during the duration 720 of the TRN unit 725-a for transmit beam training. During a next TRN unit 725-b, the device may transmit P repetitions of the TRN subfield during the duration 710 (for channel estimation and tracking). During the duration 715 of the TRN unit 725-b, the device may transmit M repetitions of the TRN subfield (such as, for beam refinement training). During the duration 710 (after the TRN unit 725-b), the device may transmit P repetitions of the TRN subfield (for channel estimation and phase tracking). During the duration 720 of the second TRN unit 725-b, N repetitions of the TRN subfield may be transmitted.

The TRN sequence may be the same as the LTF sequence. For SISO cases, the TRN sequence may equal the LTF sequence. For MIMO cases, TRN sequence may be orthogonal for different antennas or transmit chains, which may be defined by the LTF sequence and a P matrix.

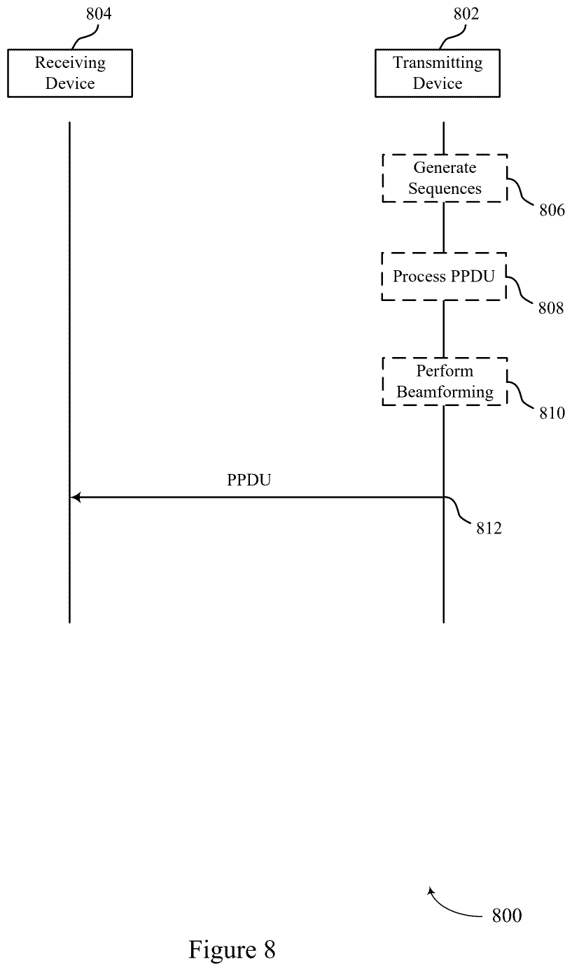

FIG. 8 shows an example of a process flow 800 that supports field design for 60 GHz PPDU format. The process flow 800 may implement, or be implemented by, aspects of the wireless communication network described with reference to FIG. 1, the PDU described with reference to FIG. 2, the PPDU described with reference to FIG. 3, the frequency diagram described with reference to FIG. 4, the wireless communication network described with reference to FIG. 5, the signaling diagram described with reference to FIG. 6, or the signaling diagram described with reference to FIG. 7. For example, a transmitting device 802 (such as an AP 102, or a STA 104), and a receive device 804 (such as an AP 102 or a STA 104), which may be an example of a corresponding device described with reference to FIGS. 1-7, may communicate in accordance with the process flow 800.

At 812, the transmitting device 802 may transmit a PPDU. The PPDU may include a preamble. The preamble may include a first segment and a second segment. The first segment may include an L-STF field, an L-LTF field, a U-SIG field, and an non-legacy-SIG field (such as an IMMW-SIG field). The second segment may include one or more STFs, one or more LTFs, or both. The second segment may optionally include a second non-legacy SIG field (such as an IMMW-SIGB field). The PPDU also may optionally include data. The PPDU may optionally include a PE field, one or more TRN fields, or both. Thus, at 812, the transmitting device 802 may transmit the preamble, optionally the data, and optionally at least one of the PE and the one or more TRN fields.

In some examples, the SCS of the preamble (such as, the subcarrier spacing of the PPDU) may be 2.5 MHz, and the duration of the L-STF may be 4 symbols. In some examples, the SCS of the preamble (such as, the PPDU) may be 1.25 MHz, a duration of the L-STF field may be 2 symbols, and a tone plan of the L-STF may include populating one tone out of every eight tones in accordance with a CFO threshold.

In some examples the first segment, the second segment, and the data may be transmitted in accordance with a first tone spacing.

In some examples, a CSD value may be applied to the first segment for each of multiple transmit chains, and the CSD value may satisfy a guard interval (GI) threshold. In such examples, MIMO transmissions may be initiated for the second segment of the preamble (such as, after a common transmission of the first segment of the preamble).

In some examples, the PPDU may be an NDP, and the PPDU may include one LTF or one LTF and one SIG symbol in which the one LTF has a duration of 1 μs for a single spatial stream, or multiple LTFs have a duration of 1 μs for each respective spatial stream of multiple spatial streams. In such examples, a training sequence of the one or more LTFs may correspond to a time domain Golay sequence including multiple orthogonal sequences for the spatial streams.

The first non-legacy-SIG field may include an indication that the second non-legacy-SIG field is present. The second non-legacy-SIG field may carry signaling information corresponding to the U-SIG field, the first non-legacy-SIG field, or both. The second non-legacy-SIG field may include a buffer symbol satisfying a time duration threshold for receiver processing. The U-SIG field may include one or more version independent fields, version dependent fields, and at least one of the U-SIG field, the first non-legacy-SIG field, or the second non-legacy-SIG field may include data demodulation information, beamforming information, or both.

The transmitting device 802 may generate multiple FD duplicates of the first segment of the preamble in accordance with a base block (such as, a 64 tone base block or allowed smallest block).

At 808, the transmitting device 802 may process the PPDU. The transmitting device 802 may process the PPDU in accordance with a tone plan for the subset of the bandwidth which may be duplicated across the bandwidth, and transmitting the PPDU may be based on the processing. For example, the tone plan may indicate which tones are populated, and according to the processing and the tone plan, the transmitting device 802 may send signaling via the populated tones. In some examples, processing the PPDU may be done in accordance with a non-duplicated tone plan corresponding to a full bandwidth.

In some examples, the PE field may be present in the PPDU, and a presence or absence of the TRN field in the PPDU may be indicated by at least one of the U-SIG field, the first non-legacy-SIG field, or the second non-legacy-SIG field if a training length is equal to zero or if a beam tracking request equals one and a training direction is set for reception training. The TRN may be present or not depending on the training length field in the SIG being set to 0 or not, or a beam tracking request may be set equal to 1 and a training direction is set to reception training. In some examples, the TRN field and the PE field may be present in the PPDU, and a bit in at least one of the U-SIG field, the first non-legacy-SIG field, or the second non-legacy-SIG field may indicate whether the TRN field or the PE field is the last field present in the PPDU. In some examples, the transmitting device 802 may generate a set of orthogonal TRN sequences for the TRN field for each of multiple transmit chains, and each TRN subfield of the TRN field may include the set of orthogonal TRN sequences.

At 806, the transmitting device 802 may generate one or more sequences. For example, the transmitting device 802 may generate a first sequence for the one or more LTFs, and may apply the first sequence to the TRN field for a single transmit chain, and each TRN subfield of the TRN field may include the first sequence.

At 810, the transmitting device 802 may perform beam forming. For example, the transmitting device 802 may perform beam forming across a single transmit chain corresponding to a single spatial stream for the PPDU, and the L-LTF may be transmitted in accordance with a first tone plan and the one or more LTFs may be transmitted in accordance with a second tone plan that is different than the first tone plan. In some examples, the beam forming may be performed for multiple transmit chains for multiple spatial streams, and the first segment of the preamble may be duplicated across each of the transmit chains and a per chain CSD may be applied. Different data and P matrix orthogonalized LTFs may be transmitted via each of the transmit chains.

In some examples, the PPDU may include the STF, the LTFs, and an U-SIG and an non-legacy-SIG field (single segment preamble format). In such examples, the transmitting device 802 may perform beam forming for multiple transmit chains, and the preamble of the PDDU and the data may be transmitted via each of the transmit chains.

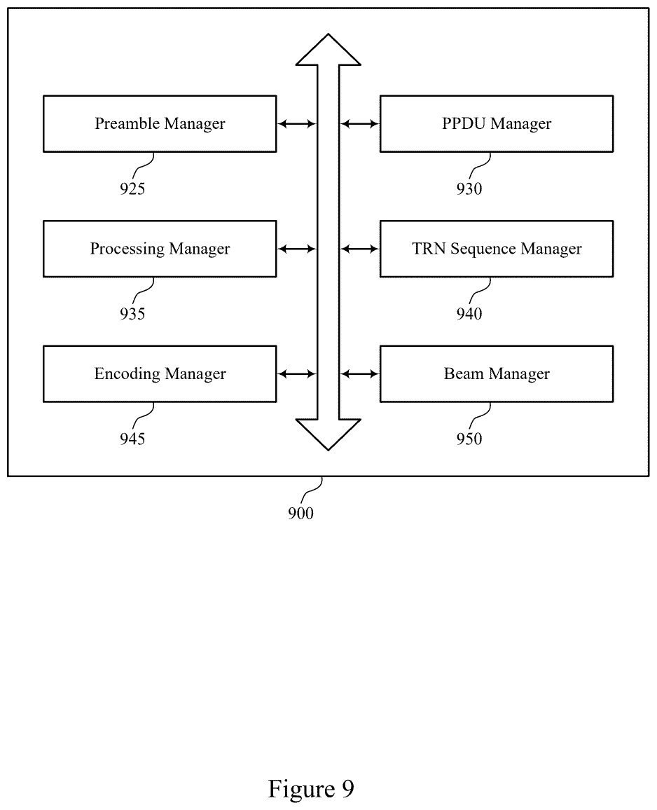

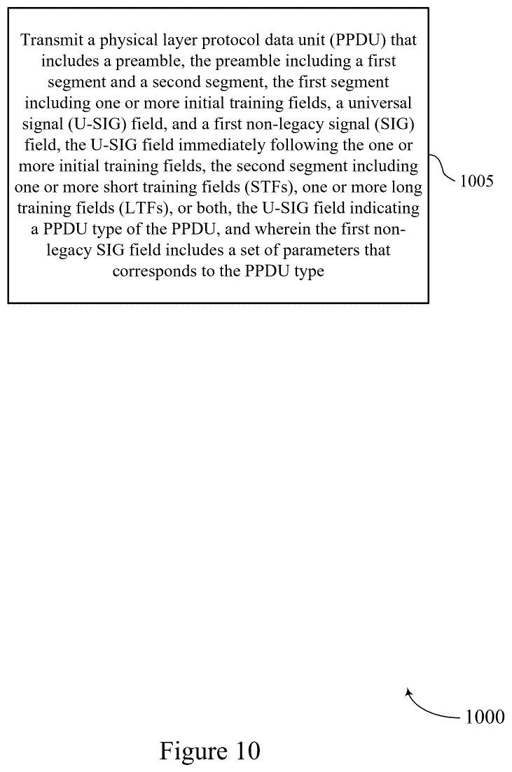

FIG. 9 shows a block diagram of an example wireless communication device 900 that supports field design for 60 GHz PPDU format. In some examples, the wireless communication device 900 is configured to perform step 812 described with reference to FIG. 8 or the method 1000 described with reference to FIG. 10. The wireless communication device 900 may include one or more chips, SoCs, chipsets, packages, components or devices that individually or collectively constitute or include a processing system. The processing system may interface with other components of the wireless communication device 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is then passed to the processing system. In some such examples, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 900 can be configurable or configured for use in a STA, such as the STA 104 described with reference to FIG. 1. In some other examples, the wireless communication device 900 can be a STA that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other examples, the wireless communication device 900 can be configurable or configured to transmit and receive signals and communications conforming to one or more 3GPP specifications including those for 5G NR or 6G. In some examples, the wireless communication device 900 also includes or can be coupled with one or more application processors which may be further coupled with one or more other memories. In some examples, the wireless communication device 900 further includes a user interface (UI) (such as a touchscreen or keypad) and a display, which may be integrated with the UI to form a touchscreen display that is coupled with the processing system. In some examples, the wireless communication device 900 may further include one or more sensors such as, for example, one or more inertial sensors, accelerometers, temperature sensors, pressure sensors, or altitude sensors, that are coupled with the processing system.

The wireless communication device 900 includes a preamble manager 925, a PPDU manager 930, a processing manager 935, a TRN sequence manager 940, an encoding manager 945, and a beam manager 950. Portions of one or more of the preamble manager 925, the PPDU manager 930, the processing manager 935, the TRN sequence manager 940, the encoding manager 945, and the beam manager 950 may be implemented at least in part in hardware or firmware. For example, one or more of the preamble manager 925, the PPDU manager 930, the processing manager 935, the TRN sequence manager 940, the encoding manager 945, and the beam manager 950 may be implemented at least in part by at least a processor or a modem. In some examples, portions of one or more of the preamble manager 925, the PPDU manager 930, the processing manager 935, the TRN sequence manager 940, the encoding manager 945, and the beam manager 950 may be implemented at least in part by a processor and software in the form of processor-executable code stored in memory.

The wireless communication device 900 may support wireless communications in accordance with examples as disclosed herein. The preamble manager 925 is configurable or configured to transmit a preamble of a PPDU, the preamble including a first segment and a second segment, the first segment including a universal signal (U-SIG) field and a first non-legacy (e.g., integrated millimeter wave) SIG field, the U-SIG field including a first SIG field immediately following one or more initial training fields, the second segment including one or more of a short training field (STF), one or more long training fields (LTFs), and a second non-legacy SIG (e.g., SIGB) field, the U-SIG field indicating a PPDU type of a set of candidate PPDU types, and the first non-legacy SIG field, the second non-legacy SIG field, or both including a set of parameters that corresponds to the PPDU type. Optionally, the PPDU manager 930 may be configurable or configured to transmit, via the PPDU, a packet extension (PE) field, one or more training (TRN) fields, or both.

In some examples, the PPDU type includes a regular data PPDU type and the set of parameters are indicated via a common field, a demodulation related field, and a data field, the common field indicating one or more of a station identifier, a cyclic redundancy check, a tail, a PE or TRN switch indicator, or a short interframe response field, and the demodulation related field indicating one or more of a guard interval and LTF field, an indication of a quantity of LTF symbols, an indication of whether the second non-legacy SIG field is present, a beamformed indication, a modulation and coding scheme field, a quantity of spatial streams, a low density parity check extra symbol segment, an indicator of low density parity check with a doubled code length, an unequal modulation indicator for a plurality of spatial streams, an additional modulation and coding scheme field for a plurality of spatial streams, or an interference mitigation indicator.

In some examples, the PPDU type corresponds to data transmission and a BRP, and the set of parameters are indicated via a common field, a demodulation related field, one or more BRP beam training related fields, and a data field, the common field indicating one or more of a station identifier, a cyclic redundancy check, a tail, a PE or TRN switch indicator, or a short interframe response field, the demodulation related field indicating one or more of a guard interval and LTF field, an indication of a quantity of LTF symbols, an indication of whether the second non-legacy SIG field is present, a beamformed indication, a modulation and coding scheme field, a quantity of spatial streams, a low density parity check extra symbol segment, an indicator of low density parity check with a doubled code length, an unequal modulation indicator for a plurality of spatial streams, an additional modulation and coding scheme field for a plurality of spatial streams, or an interference mitigation indicator, and the one or more BRP beam training related fields indicating one or more of a training direction, a beam tracking request, a beam tracking request type, a quantity of transmit chains, a training length, a reception TRN-units per transmit TRN-unit, a TRN-unit P value, a TRN-unit M value, a TRN-unit N value, a TRN subfield sequence length, or a reception pattern in BRP transmission.

In some examples, the PPDU type includes a BRP PPDU type and the set of parameters are indicated via a common field and one or more BRP beam training related fields, the common field indicating one or more of a station identifier, a cyclic redundancy check, a tail, a PE or TRN switch indicator, or a short interframe response field, and the one or more BRP beam training related fields indicating one or more of a training direction, a beam tracking request, a beam tracking request type, a dual polarization TRN training indicator, a training length, a receiver TRN-units for each transmitter TRN-unit, a TRN-unit P value, a TRN-unit M value, a TRN-unit N value, a TRN subfield sequence length, or a reception pattern in BRP transmission.

In some examples, the PPDU types includes an SSW PPDU types and the set of parameters are indicated via a common field and one or more SSW NDP related fields, the common field indicating one or more of a station identifier, a cyclic redundancy check, a tail, a PE or TRN switch indicator, or a short interframe response field, and the one or more SSW NDP related fields indicating one or more of a first training direction, a second training direction, an addressing mode, a multiple sector identifier capture indication, a training length, a count down, a radio frequency chain identifier, a sector identifier, an antenna identifier, a quantity of receive antennas or receive patterns, a list of sector identifiers selected, a list of antenna identifiers selected, a signal-to-noise ratio report, or a quantity of transmit chains.

In some examples, at least a portion of the first segment of the preamble corresponds to a first tone plan and at least a portion of the second segment of the preamble corresponds to a second tone plan that is different than the first tone plan.

In some examples, an entirety of the PPDU corresponds to a single SCS.

In some examples, the first segment of the preamble corresponds to a first SCS, and the second segment of the preamble or a data field correspond to a second SCS, the first SCS being different than the second SCS. The optional PE field, one or more TRN fields, or both may also correspond to the second SCS.

In some examples, the first segment further includes an L-STF, a legacy L-LTF, or both.

In some examples, a subcarrier spacing of the preamble is 2.5 MHz, and a duration of the L-STF field is 4 symbols.

In some examples, a subcarrier spacing of the preamble is 1.25 MHz, a duration of the L-STF field is 2 symbols, and a tone plan of the L-STF includes populating one tone out of every eight tones in accordance with a carrier frequency offset (CFO) threshold.

In some examples, a cyclic shift delay (CSD) value is applied on the first segment for each of a set of multiple transmit chains and the CSD value satisfies a guard interval threshold. In some examples, multiple input multiple output (MIMO) transmissions are initiated for the second segment of the preamble after common transmission of the first segment of the preamble.

In some examples, the PPDU includes a null data packet (NDP), and the PPDU includes one LTF or one LTF plus one SIG symbol in which the one LTF has a duration of 1 μs for a single spatial stream, or includes a set of multiple LTFs that have durations of 1 μs for each respective spatial stream of a set of multiple spatial streams.

In some examples, a training sequence of the one or more LTFs corresponds to a time domain Golay sequence including multiple orthogonal sequences for a set of multiple spatial streams.

In some examples, the processing manager 935 is configurable or configured to process the PPDU in accordance with a tone plan indicating which tones of a set of multiple candidate tones of a subset of a bandwidth are populated, where the tone plan for the subset of the bandwidth is duplicated across the bandwidth, and where transmitting the PPDU is based on the processing.

In some examples, the processing manager 935 is configurable or configured to process the PPDU in accordance with a non-duplicated tone plan corresponding to a bandwidth, where transmitting the PPDU via the bandwidth is based on the processing.

In some examples, the PE field is present in the PPDU, a presence or absence of the TRN field in the PPDU is indicated by at least one of the U-SIG field, the first non-legacy-SIG field, or the second non-legacy-SIG field if a training length is equal to zero or if a beam tracking request equals one and a training direction is set for reception training.

In some examples, both the TRN field and the PE field are present in the PPDU, and a bit in at least one of the U-SIG field, the first non-legacy-SIG field, or the second non-legacy-SIG field, indicates whether the TRN field or the PE field is a last field present in the PPDU.

In some examples, the TRN sequence manager 940 is configurable or configured to generate a set of orthogonal TRN sequence for the TRN field for each of a set of multiple transmit chains, where each TRN subfield of the TRN field includes the set of orthogonal TRN sequences.

In some examples, the TRN sequence manager 940 is configurable or configured to generate a first sequence for the one or more LTFs. In some examples, the TRN sequence manager 940 is configurable or configured to apply the first sequence to the TRN field for a single transmit chain, where each TRN subfield of the TRN field includes the first sequence.

In some examples, the first non-legacy-SIG field includes an indication that the second non-legacy-SIG field is present, and the second non-legacy-SIG field carries signaling information corresponding to the U-SIG field, the first non-legacy-SIG field, or both.

In some examples, the second non-legacy-SIG field includes a buffer symbol satisfying a time duration threshold for receiver processing.

In some examples, the U-SIG field includes one or more of one or more version independent fields, one or more version dependent fields. In some examples, at least one of the U-SIG field, the first non-legacy-SIG field, or the second non-legacy-SIG field includes data demodulation information, beamforming information, or both.

In some examples, the encoding manager 945 is configurable or configured to separately encode the U-SIG field and the first non-legacy-SIG field, where a first modulation is applied to the U-SIG field and a second modulation is applied to the first non-legacy-SIG field.

In some examples, the preamble manager 925 is configurable or configured to generate a set of multiple frequency domain duplicates of the first segment of the preamble in accordance with a base block including sixty-four tones.

In some examples, the beam manager 950 is configurable or configured to perform beam forming across a single transmit chain corresponding to a single spatial stream for the PPDU, where the L-LTF is transmitted in accordance with a first tone plan and the one or more LTFs are transmitted in accordance with a second tone plan that is different than the first tone plan.

In some examples, the beam manager 950 is configurable or configured to perform beam forming for a set of multiple transmit chains corresponding to a set of multiple spatial streams, where the first segment of the preamble is duplicated across each of the set of multiple transmit chains and a per chain cyclic shift delay (CSD) is applied, and where different data and matrix orthogonalized LTFs are transmitted via each of the set of multiple transmit chains.

In some examples, the PPDU manager 930 is configurable or configured to generate a second PPDU, a preamble of the second PPDU including a second STF, one or more second LTFs, and a third non-legacy SIG (e.g., SIGB) field. In some examples, the beam manager 950 is configurable or configured to perform beam forming for a set of multiple transmit chains, the preamble of the second PPDU and data of the second PPDU are transmitted via each of the set of multiple transmit chains in accordance with the beam forming.

In some examples, the preamble of the PPDU including the first segment and the second segment and the data are transmitted in accordance with a first tone spacing.

FIG. 10 shows an example method 1000 at an apparatus that supports field design for 60 GHz PPDU format. The method 1000 may be implemented by an apparatus or its components as described herein. For example, the method 1000 may be performed by a wireless communication device, such as the wireless communication device 900 described with reference to FIG. 9, operating as or within a wireless STA. In some examples, the method 1000 may be performed by a wireless STA, such as one of the STAs 104 described with reference to FIG. 1.

In 1005, the apparatus may transmit a PPDU including a preamble, the preamble including a first segment and a second segment, the first segment including one or more initial training fields, a U-SIG field and a first non-legacy SIG field, the U-SIG field immediately following the one or more initial training fields, the second segment including one or more STFs, one or more LTFs, or both, the U-SIG field indicating a PPDU type of the PPDU, and wherein the first non-legacy SIG field includes a set of parameters that corresponds to the PPDU type. In some implementations, aspects of the operations of 1005 may be performed by a preamble manager 925 as described with reference to FIG. 9.

In some examples, the PPDU may optionally further include a PE field, one or more TRN fields, or both. In some implementations, transmission of the PE field, the one or more TRN fields, or both may be performed by a PPDU manager 930 as described with reference to FIG. 9.

Implementation examples are described in the following numbered clauses:

Aspect 1: A method for wireless communications, comprising: transmitting a physical layer protocol data unit (PPDU) that includes: a preamble that includes a first segment and a second segment, the first segment comprising one or more initial training fields, a universal signal (U-SIG) field, and a first non-legacy (SIG) field, the U-SIG field immediately following the one or more initial training fields, the second segment comprising one or more short training fields (STFs), one or more long training fields (LTFs), or both, the U-SIG field indicating a PPDU type of the PPDU, and wherein the first non-legacy SIG field comprises a set of parameters that corresponds to the PPDU type.

Aspect 2: The method of aspect 1, wherein the PPDU type comprises a regular data PPDU type, the PPDU comprising a data field in accordance with a data PPDU type, and wherein the set of parameters are indicated via a common field and a demodulation related field, wherein the common field indicates one or more of a station identifier, a cyclic redundancy check, a tail, a PE or TRN switch indicator, or a short interframe response field, and wherein the demodulation related field indicates one or more of a guard interval and LTF field, an indication of a quantity of LTF symbols, an indication of whether a second non-legacy SIG field is present within the second segment, a beamformed indication, a modulation and coding scheme field, a quantity of spatial streams, a low density parity check extra symbol segment, an indicator of low density parity check with a doubled code length, an unequal modulation indicator for a plurality of spatial streams, an additional modulation and coding scheme field for a plurality of spatial streams, or an interference mitigation indicator.

Aspect 3: The method of any of aspects 1 through 2, wherein the PPDU type corresponds to data transmission and a beam refinement procedure (BRP), the PPDU comprising a data field in accordance with the PPDU type corresponding to the data transmission and the BRP, and wherein the set of parameters are indicated via a common field, a demodulation related field, and one or more BRP beam training related fields, wherein the common field indicates one or more of a station identifier, a cyclic redundancy check, a tail, a PE or TRN switch indicator, or a short interframe response field, wherein the demodulation related field indicates one or more of a guard interval and LTF field, an indication of a quantity of LTF symbols, an indication of whether a second non-legacy SIG field is present within the second segment, a beamformed indication, a modulation and coding scheme field, a quantity of spatial streams, a low density parity check extra symbol segment, an indicator of low density parity check with a doubled code length, an unequal modulation indicator for a plurality of spatial streams, an additional modulation and coding scheme field for a plurality of spatial streams, or an interference mitigation indicator, and wherein the one or more BRP beam training related fields indicate one or more of a training direction, a beam tracking request, a beam tracking request type, a quantity of transmit chains, a training length, a reception TRN-units per transmit TRN-unit, a TRN-unit P value, a TRN-unit M value, a TRN-unit N value, a TRN subfield sequence length, or a reception pattern in BRP transmission.

Aspect 4: The method of any of aspects 1 through 3, wherein the PPDU type comprises a beam refinement procedure (BRP) PPDU type, and wherein the set of parameters are indicated via a common field and one or more BRP beam training related fields, wherein the common field indicates one or more of a station identifier, a cyclic redundancy check, a tail, a PE or TRN switch indicator, or a short interframe response field, and wherein the one or more BRP beam training related fields indicate one or more of a training direction, a beam tracking request, a beam tracking request type, a dual polarization TRN training indicator, a training length, a receiver TRN-units for each transmitter TRN-unit, a TRN-unit P value, a TRN-unit M value, a TRN-unit N value, a TRN subfield sequence length, or a reception pattern in BRP transmission.

Aspect 5: The method of any of aspects 1 through 4, wherein the PPDU type comprises a sector sweep (SSW) PPDU type, and wherein the set of parameters are indicated via a common field and one or more SSW null data packet (NDP) related fields, wherein the common field indicates one or more of a station identifier, a cyclic redundancy check, a tail, a PE or TRN switch indicator, or a short interframe response field, and wherein the one or more SSW NDP related fields indicate one or more of a first training direction, a second training direction, an addressing mode, a multiple sector identifier capture indication, a training length, a count down, a radio frequency chain identifier, a sector identifier, an antenna identifier, a quantity of receive antennas or receive patterns, a list of sector identifiers selected, a list of antenna identifiers selected, a signal-to-noise ratio report, or a quantity of transmit chains.

Aspect 6: The method of any of aspects 1 through 5, wherein at least a portion of the first segment of the preamble corresponds to a first tone plan and at least a portion of the second segment of the preamble corresponds to a second tone plan that is different than the first tone plan.

Aspect 7: The method of any of aspects 1 through 6, wherein an entirety of the PPDU corresponds to a single subcarrier spacing (SCS).

Aspect 8: The method of any of aspects 1 through 7, wherein the first segment further comprises a legacy short training field (L-STF), a legacy long training field (L-LTF), or both.

Aspect 9: The method of any of aspects 1 through 8, wherein a subcarrier spacing of the preamble is 2.5 MHz, and a duration of the L-STF field is 4 symbols.

Aspect 10: The method of any of aspects 1 through 9, wherein a subcarrier spacing of the preamble is 1.25 MHz, a duration of the L-STF field is 2 symbols, and a tone plan of the L-STF comprises populating one tone out of every eight tones in accordance with a carrier frequency offset (CFO) threshold.

Aspect 11: The method of any of aspects 1 through 10, wherein a cyclic shift delay (CSD) value is applied on the first segment for each of a plurality of transmit chains and the CSD value satisfies a guard interval threshold, and multiple input multiple output (MIMO) transmissions are initiated for the second segment of the preamble after common transmission of the first segment of the preamble.

Aspect 12: The method of any of aspects 1 through 11, wherein the PPDU comprises a null data packet (NDP), and the PPDU comprises one LTF or one LTF plus one SIG symbol in which the one LTF has a duration of 1 s for a single spatial stream, or comprises a plurality of LTFs that have durations of 1 s for each respective spatial stream of a plurality of spatial streams.

Aspect 13: The method of aspect 12, wherein a training sequence of the one or more LTFs corresponds to a time domain Golay sequence comprising multiple orthogonal sequences for a plurality of spatial streams.

Aspect 14: The method of any of aspects 1 through 13, further comprising: processing the PPDU in accordance with a tone plan indicating which tones of a plurality of candidate tones of a subset of a bandwidth are populated, wherein the tone plan for the subset of the bandwidth is duplicated across the bandwidth, and wherein transmitting the PPDU is based at least in part on the processing.

Aspect 15: The method of any of aspects 1 through 14, further comprising: processing the PPDU in accordance with a non-duplicated tone plan corresponding to a bandwidth, wherein transmitting the PPDU via the bandwidth is based at least in part on the processing.

Aspect 16: The method of any of aspects 1 through 15, wherein the second segment further comprises a second non-legacy SIG field, the PPDU further comprises at least one of a packet extension (PE) field or one or more training (TRN) fields, or both.

Aspect 17: The method of aspect 16, wherein the first segment of the preamble corresponds to a first subcarrier spacing (SCS), and the second segment of the preamble and at least one of the PE field, the one or more TRN fields, or a data field correspond to a second SCS, the first SCS being different than the second SCS.

Aspect 18: The method of aspect 16, wherein the PE field is present in the PPDU, a presence or absence of the one or more TRN fields in the PPDU is indicated by at least one of the U-SIG field, the first non-legacy-SIG field, or the second non-legacy-SIG field if a training length is equal to zero or if a beam tracking request equals one and a training direction is set for reception training.

Aspect 19: The method of aspect 16, wherein both the one or more TRN fields and the PE field are present in the PPDU, and a bit in at least one of the U-SIG field, the first non-legacy-SIG field, or the second non-legacy-SIG field, indicates whether the one or more TRN fields or the PE field is a last field present in the PPDU.

Aspect 20: The method of aspect 16, further comprising: generating a set of orthogonal TRN sequence for the one or more TRN fields for each of a plurality of transmit chains, wherein each TRN subfield of the one or more TRN fields includes the set of orthogonal TRN sequences.

Aspect 21: The method of aspect 16, further comprising: generating a first sequence for the one or more LTFs; and applying the first sequence to the one or more TRN fields for a single transmit chain, wherein each TRN subfield of the one or more TRN fields includes the first sequence.

Aspect 22: The method of any of aspect 16, wherein the first non-legacy SIG field comprises an indication that the second non-legacy-SIG field is present, and the second non-legacy-SIG field carries signaling information corresponding to the U-SIG field, the first non-legacy-SIG field, or both.

Aspect 23: The method of aspect 16, wherein the second non-legacy-SIG field comprises a buffer symbol satisfying a time duration threshold for receiver processing.

Aspect 24: The method of aspect 16, wherein the U-SIG field comprises one or more of one or more version independent fields, one or more version dependent fields, at least one of the U-SIG field, the first non-legacy-SIG field, or the second non-legacy-SIG field comprises data demodulation information, beamforming information, or both.

Aspect 25: The method of any of aspects 1 through 24, further comprising: separately encoding the U-SIG field and the first non-legacy-SIG field, wherein a first modulation is applied to the U-SIG field and a second modulation is applied to the first non-legacy-SIG field.

Aspect 26: The method of any of aspects 1 through 25, further comprising: generating a plurality of frequency domain duplicates of the first segment of the preamble in accordance with a base block comprising sixty-four tones.

Aspect 27: The method of any of aspects 1 through 26, further comprising: performing beam forming across a single transmit chain corresponding to a single spatial stream for the PPDU, wherein an L-LTF included in the first segment is transmitted in accordance with a first tone plan and the one or more LTFs are transmitted in accordance with a second tone plan that is different than the first tone plan.

Aspect 28: The method of any of aspects 1 through 27, further comprising: performing beam forming for a plurality of transmit chains corresponding to a plurality of spatial streams, wherein the first segment of the preamble is duplicated across each of the plurality of transmit chains and a per chain cyclic shift delay (CSD) is applied, and wherein different data and matrix orthogonalized LTFs are transmitted via each of the plurality of transmit chains.

Aspect 29: The method of any of aspects 1 through 28, further comprising: generating a second PPDU, a preamble of the second PPDU comprising a second STF, one or more second LTFs, and a third non-legacy-SIG (e.g., SIGB) field; and performing beam forming for a plurality of transmit chains, the preamble of the second PPDU and data of the second PPDU are transmitted via each of the plurality of transmit chains in accordance with the beam forming.

Aspect 30: The method of any of aspects 1 through 29, wherein the preamble of the PPDU comprising the first segment and the second segment and the data are transmitted in accordance with a first tone spacing.

Aspect 31: A method for wireless communications, comprising: receiving a physical layer protocol data unit (PPDU) that includes: a preamble that includes a first segment and a second segment, the first segment comprising one or more initial training fields, a universal signal (U-SIG) field, and a first non-legacy (SIG) field, the U-SIG field immediately following the one or more initial training fields, the second segment comprising one or more short training fields (STFs), one or more long training fields (LTFs), or both, the U-SIG field indicating a PPDU type of the PPDU, and wherein the first non-legacy SIG field comprises a set of parameters that corresponds to the PPDU type.

Aspect 32: The method of aspect 31, wherein the PPDU type comprises a regular data PPDU type, the PPDU comprising a data field in accordance with a data PPDU type, and wherein the set of parameters are indicated via a common field and a demodulation related field, wherein the common field indicates one or more of a station identifier, a cyclic redundancy check, a tail, a PE or TRN switch indicator, or a short interframe response field, and wherein the demodulation related field indicates one or more of a guard interval and LTF field, an indication of a quantity of LTF symbols, an indication of whether a second non-legacy SIG field is present within the second segment, a beamformed indication, a modulation and coding scheme field, a quantity of spatial streams, a low density parity check extra symbol segment, an indicator of low density parity check with a doubled code length, an unequal modulation indicator for a plurality of spatial streams, an additional modulation and coding scheme field for a plurality of spatial streams, or an interference mitigation indicator.

Aspect 33: The method of any of aspects 31 through 32, wherein the PPDU type corresponds to data transmission and a beam refinement procedure (BRP), the PPDU comprising a data field in accordance with the PPDU type corresponding to the data transmission and the BRP, and wherein the set of parameters are indicated via a common field, a demodulation related field, and one or more BRP beam training related fields, wherein the common field indicates one or more of a station identifier, a cyclic redundancy check, a tail, a PE or TRN switch indicator, or a short interframe response field, wherein the demodulation related field indicates one or more of a guard interval and LTF field, an indication of a quantity of LTF symbols, an indication of whether a second non-legacy SIG field is present within the second segment, a beamformed indication, a modulation and coding scheme field, a quantity of spatial streams, a low density parity check extra symbol segment, an indicator of low density parity check with a doubled code length, an unequal modulation indicator for a plurality of spatial streams, an additional modulation and coding scheme field for a plurality of spatial streams, or an interference mitigation indicator, and wherein the one or more BRP beam training related fields indicate one or more of a training direction, a beam tracking request, a beam tracking request type, a quantity of transmit chains, a training length, a reception TRN-units per transmit TRN-unit, a TRN-unit P value, a TRN-unit M value, a TRN-unit N value, a TRN subfield sequence length, or a reception pattern in BRP transmission.

Aspect 34: The method of any of aspects 31 through 33, wherein the PPDU type comprises a beam refinement procedure (BRP) PPDU type, and wherein the set of parameters are indicated via a common field and one or more BRP beam training related fields, wherein the common field indicates one or more of a station identifier, a cyclic redundancy check, a tail, a PE or TRN switch indicator, or a short interframe response field, and wherein the one or more BRP beam training related fields indicate one or more of a training direction, a beam tracking request, a beam tracking request type, a dual polarization TRN training indicator, a training length, a receiver TRN-units for each transmitter TRN-unit, a TRN-unit P value, a TRN-unit M value, a TRN-unit N value, a TRN subfield sequence length, or a reception pattern in BRP transmission.

Aspect 35: The method of any of aspects 30 through 34, wherein the PPDU type comprises a sector sweep (SSW) PPDU type, and wherein the set of parameters are indicated via a common field and one or more SSW null data packet (NDP) related fields, wherein the common field indicates one or more of a station identifier, a cyclic redundancy check, a tail, a PE or TRN switch indicator, or a short interframe response field, and wherein the one or more SSW NDP related fields indicate one or more of a first training direction, a second training direction, an addressing mode, a multiple sector identifier capture indication, a training length, a count down, a radio frequency chain identifier, a sector identifier, an antenna identifier, a quantity of receive antennas or receive patterns, a list of sector identifiers selected, a list of antenna identifiers selected, a signal-to-noise ratio report, or a quantity of transmit chains.

Aspect 36: The method of any of aspects 31 through 35, wherein at least a portion of the first segment of the preamble corresponds to a first tone plan and at least a portion of the second segment of the preamble corresponds to a second tone plan that is different than the first tone plan.

Aspect 37: The method of any of aspects 31 through 36, wherein an entirety of the PPDU corresponds to a single subcarrier spacing (SCS).

Aspect 38: The method of any of aspects 31 through 37, wherein the first segment further comprises a legacy short training field (L-STF), a legacy long training field (L-LTF), or both.

Aspect 39: The method of any of aspects 31 through 38, wherein a subcarrier spacing of the preamble is 2.5 MHz, and a duration of the L-STF is 4 symbols.

Aspect 40: The method of any of aspects 31 through 39, wherein a subcarrier spacing of the preamble is 1.25 MHz, a duration of the L-STF is 2 symbols, and a tone plan of the L-STF comprises populating one tone out of every eight tones in accordance with a carrier frequency offset (CFO) threshold.

Aspect 41: The method of any of aspects 31 through 40, wherein a cyclic shift delay (CSD) value is applied on the first segment for each of a plurality of transmit chains and the CSD value satisfies a guard interval threshold, and multiple input multiple output (MIMO) transmissions are initiated for the second segment of the preamble after common transmission of the first segment of the preamble.

Aspect 42: The method of any of aspects 31 through 41, wherein the PPDU comprises a null data packet (NDP), and the PPDU comprises one LTF or one LTF plus one SIG symbol in which the one LTF has a duration of 1 s for a single spatial stream, or comprises a plurality of LTFs that have durations of 1 s for each respective spatial stream of a plurality of spatial streams.

Aspect 43: The method of any of aspects 31 through 42, wherein a training sequence of the one or more LTFs corresponds to a time domain Golay sequence comprising multiple orthogonal sequences for a plurality of spatial streams.

Aspect 44: The method of any of aspects 31 through 43, wherein a tone plan for the subset of the bandwidth is duplicated across the bandwidth, and receiving the PPDU is based at least in part on the tone plan.

Aspect 45: The method of any of aspects 31 through 44, wherein a non-duplicated tone plan corresponds to a bandwidth, and receiving the PPDU via the bandwidth is based at least in part on the non-duplicated tone plan.

Aspect 46: The method of any of aspects 31 through 45, wherein the second segment further comprises a second non-legacy SIG field, the PPDU further comprises at least one of a packet extension (PE) field or one or more training (TRN) fields, or both.

Aspect 47: The method of aspect 46, wherein the first segment of the preamble corresponds to a first subcarrier spacing (SCS), and the second segment of the preamble and at least one of the PE field, the TRN field, or a data field correspond to a second SCS, the first SCS being different than the second SCS.

Aspect 48: The method of aspect 46, wherein the PE field is present in the PPDU, a presence or absence of the one or more TRN fields in the PPDU is indicated by at least one of the U-SIG field, the first non-legacy-SIG field, or the second non-legacy-SIG field if a training length is equal to zero or if a beam tracking request equals one and a training direction is set for reception training.

Aspect 49: The method of aspect 46, wherein both the one or more TRN fields and the PE field are present in the PPDU, and a bit in at least one of the U-SIG field, the first non-legacy-SIG field, or the second non-legacy-SIG field, indicates whether the one or more TRN fields or the PE field is a last field present in the PPDU.

Aspect 50: The method of aspect 46, wherein each TRN subfield of the one or more TRN fields includes a set of orthogonal TRN sequences.

Aspect 51: The method of aspect 46, wherein each TRN subfield of the one or more TRN fields includes a first sequence corresponding to the one or more LTFs.

Aspect 52: The method of aspect 46, wherein the first non-legacy-SIG field comprises an indication that the second non-legacy-SIG field is present, and the second non-legacy-SIG field carries signaling information corresponding to the U-SIG field, the first non-legacy-SIG field, or both.

Aspect 53: The method of aspect 46, wherein the second non-legacy-SIG field comprises a buffer symbol satisfying a time duration threshold for receiver processing.

Aspect 54: The method of aspect 46, wherein the U-SIG field comprises one or more of one or more version independent fields, one or more version dependent fields, and at least one of the U-SIG field, the first non-legacy-SIG field, or the second non-legacy-SIG field comprises data demodulation information, beamforming information, or both.

Aspect 55: The method of any of aspects 31 through 54, further comprising: separately decoding the U-SIG field and the first non-legacy-SIG field, wherein a first modulation is applied to the U-SIG field and a second modulation is applied to the first non-legacy-SIG field.

Aspect 56: The method of any of aspects 31 through 55, further comprising: decoding a plurality of frequency domain duplicates of the first segment of the preamble in accordance with a base block comprising sixty-four tones.

Aspect 57: The method of any of aspects 31 through 56, wherein an L-LTF included in the first segment is received in accordance with the first tone plan and the one or more LTFs are received in accordance with the second tone plan that is different than the first tone plan.

Aspect 58: The method of any of aspects 31 through 57, wherein the first segment of the preamble is duplicated across each of a plurality of streams and a per chain cyclic shift delay (CSD) is applied, and different data and matrix orthogonalized LTFs are received via each of the plurality of streams.

Aspect 59: The method of any of aspects 31 through 58, further comprising: receiving a second PPDU, a preamble of the second PPDU comprising a second STF, one or more second LTFs, and a third non-legacy-SIG (e.g., SIGB) field, wherein the preamble of the second PPDU and data of the second PPDU are received via each of a plurality of streams.

Aspect 60: The method of any of aspects 31 through 59, wherein the preamble of the PPDU comprising the first segment and the second segment and the data are transmitted in accordance with a first tone spacing.

Aspect 61: An apparatus for wireless communications, comprising a processing system that includes processor circuitry and memory circuitry that stores code, the processing system configured to cause the apparatus to perform a method of any of aspects 1 through 30.

Aspect 62: An apparatus for wireless communications, comprising at least one means for performing a method of any of aspects 1 through 30.

Aspect 63: A non-transitory computer-readable medium storing code for wireless communications, the code comprising instructions executable by one or more processors to perform a method of any of aspects 1 through 30.

Aspect 64: An apparatus for wireless communications, comprising a processing system that includes processor circuitry and memory circuitry that stores code, the processing system configured to cause the apparatus to perform a method of any of aspects 31 through 60.

Aspect 65: An apparatus for wireless communications, comprising at least one means for performing a method of any of aspects 31 through 60.

Aspect 66: A non-transitory computer-readable medium storing code for wireless communications, the code comprising instructions executable by one or more processors to perform a method of any of aspects 31 through 60.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus, comprising:
a processing system that includes processor circuitry and memory circuitry that stores code, the processing system configured to cause the apparatus to:
transmit a physical layer protocol data unit (PPDU) that includes:
a preamble that include a first segment and a second segment, the first segment comprising one or more initial training fields, a universal signal (U-SIG) field, and a first non-legacy signal (SIG) field, the U-SIG field immediately following the one or more initial training fields, the second segment comprising one or more short training fields (STFs), one or more long training fields (LTFs), or both, the U-SIG field indicating a PPDU type of the PPDU, and wherein the first non-legacy SIG field comprises a set of parameters that corresponds to the PPDU type.

2. The apparatus of claim 1, wherein the PPDU type comprises a regular data PPDU type, the PPDU comprising a data field in accordance with a data PPDU type, and wherein the set of parameters are indicated via a common field and a demodulation related field,
wherein the common field indicates one or more of a station identifier, a cyclic redundancy check, a tail, a PE or TRN switch indicator, or a short interframe response field, and
wherein the demodulation related field indicates one or more of a guard interval and LTF field, an indication of a quantity of LTF symbols, an indication of whether a second non-legacy SIG field is present within the second segment, a beamformed indication, a modulation and coding scheme field, a quantity of spatial streams, a low density parity check extra symbol segment, an indicator of low density parity check with a doubled code length, an unequal modulation indicator for a plurality of spatial streams, an additional modulation and coding scheme field for a plurality of spatial streams, or an interference mitigation indicator.

3. The apparatus of claim 1, wherein the PPDU type corresponds to data transmission and a beam refinement procedure (BRP), the PPDU comprising a data field in accordance with the PPDU type corresponding to the data transmission and the BRP, and wherein the set of parameters are indicated via a common field, a demodulation related field, and one or more BRP beam training related fields,
wherein the common field indicates one or more of a station identifier, a cyclic redundancy check, a tail, a PE or TRN switch indicator, or a short interframe response field,
wherein the demodulation related field indicates one or more of a guard interval and LTF field, an indication of a quantity of LTF symbols, an indication of whether a second non-legacy SIG field is present within the second segment, a beamformed indication, a modulation and coding scheme field, a quantity of spatial streams, a low density parity check extra symbol segment, an indicator of low density parity check with a doubled code length, an unequal modulation indicator for a plurality of spatial streams, an additional modulation and coding scheme field for a plurality of spatial streams, or an interference mitigation indicator, and
wherein the one or more BRP beam training related fields indicate one or more of a training direction, a beam tracking request, a beam tracking request type, a quantity of transmit chains, a training length, a reception TRN-units per transmit TRN-unit, a TRN-unit P value, a TRN-unit M value, a TRN-unit N value, a TRN subfield sequence length, or a reception pattern in BRP transmission.

4. The apparatus of claim 1, wherein the PPDU type comprises a beam refinement procedure (BRP) PPDU type, and wherein the set of parameters are indicated via a common field and one or more BRP beam training related fields,
wherein the common field indicates one or more of a station identifier, a cyclic redundancy check, a tail, a PE or TRN switch indicator, or a short interframe response field, and
wherein the one or more BRP beam training related fields indicate one or more of a training direction, a beam tracking request, a beam tracking request type, a dual polarization TRN training indicator, a training length, a receiver TRN-units for each transmitter TRN-unit, a TRN-unit P value, a TRN-unit M value, a TRN-unit N value, a TRN subfield sequence length, or a reception pattern in BRP transmission.

5. The apparatus of claim 1, wherein the PPDU type comprises a sector sweep (SSW) PPDU type, and wherein the set of parameters are indicated via a common field and one or more SSW null data packet (NDP) related fields,
wherein the common field indicates one or more of a station identifier, a cyclic redundancy check, a tail, a PE or TRN switch indicator, or a short interframe response field, and
wherein the one or more SSW NDP related fields indicate one or more of a first training direction, a second training direction, an addressing mode, a multiple sector identifier capture indication, a training length, a count down, a radio frequency chain identifier, a sector identifier, an antenna identifier, a quantity of receive antennas or receive patterns, a list of sector identifiers selected, a list of antenna identifiers selected, a signal-to-noise ratio report, or a quantity of transmit chains.

6. The apparatus of claim 1, wherein at least a portion of the first segment of the preamble corresponds to a first tone plan and at least a portion of the second segment of the preamble corresponds to a second tone plan that is different than the first tone plan.

7. The apparatus of claim 1, wherein an entirety of the PPDU corresponds to a single subcarrier spacing (SCS).

8. The apparatus of claim 1, wherein the first segment further comprises a legacy short training field (L-STF), a legacy long training field (L-LTF), or both.

9. The apparatus of claim 8, wherein a subcarrier spacing of the preamble is 2.5 MHz, and a duration of the L-STF is 4 symbols.

10. The apparatus of claim 8, wherein a subcarrier spacing of the preamble is 1.25 MHz, a duration of the L-STF is 2 symbols, and a tone plan of the L-STF comprises populating one tone out of every eight tones in accordance with a carrier frequency offset (CFO) threshold.

11. The apparatus of claim 1, wherein a cyclic shift delay (CSD) value is applied on the first segment for each of a plurality of transmit chains and the CSD value satisfies a guard interval threshold, and multiple input multiple output (MIMO) transmissions are initiated for the second segment of the preamble after common transmission of the first segment of the preamble.

12. The apparatus of claim 1, wherein the PPDU comprises a null data packet (NDP), and the PPDU comprises one LTF or one LTF plus one SIG symbol in which the one LTF has a duration of 1 μs for a single spatial stream, or comprises a plurality of LTFs that have durations of 1 μs for each respective spatial stream of a plurality of spatial streams.

13. The apparatus of claim 12, wherein a training sequence of the one or more LTFs corresponds to a time domain Golay sequence comprising multiple orthogonal sequences for a plurality of spatial streams.

14. The apparatus of claim 1, wherein the processing system is further configured to cause the apparatus to:
process the PPDU in accordance with a tone plan indicating which tones of a plurality of candidate tones of a subset of a bandwidth are populated, wherein the tone plan for the subset of the bandwidth is duplicated across the bandwidth, and wherein transmitting the PPDU is based at least in part on the processing.

15. The apparatus of claim 1, wherein the processing system is further configured to cause the apparatus to:
process the PPDU in accordance with a non-duplicated tone plan corresponding to a bandwidth, wherein transmitting the PPDU via the bandwidth is based at least in part on the processing.

16. The apparatus of claim 1, wherein the second segment further comprises a second non-legacy SIG field, the PPDU further comprises at least one of a packet extension (PE) field or one or more training (TRN) fields, or both.

17. The apparatus of claim 16, wherein the first segment of the preamble corresponds to a first subcarrier spacing (SCS), and the second segment of the preamble and at least one of the PE field, the one or more TRN fields, or a data field correspond to a second SCS, the first SCS being different than the second SCS.

18. The apparatus of claim 16, wherein the PE field is present in the PPDU, a presence or absence of the one or more TRN fields in the PPDU is indicated by at least one of the U-SIG field, the first non-legacy SIG field, or the second non-legacy SIG field if a training length is equal to zero or if a beam tracking request equals one and a training direction is set for reception training.

19. The apparatus of claim 16, wherein both the one or more TRN fields and the PE field are present in the PPDU, and a bit in at least one of the U-SIG field, the first non-legacy SIG field, or the second non-legacy SIG field, indicates whether the one or more TRN fields or the PE field is a last field present in the PPDU.

20. The apparatus of claim 16, wherein the processing system is further configured to cause the apparatus to:
generate a set of orthogonal TRN sequences for the one or more TRN fields for each of a plurality of transmit chains, wherein each TRN subfield of the one or more TRN fields includes the set of orthogonal TRN sequences.

21. The apparatus of claim 16, wherein the processing system is further configured to cause the apparatus to:
generate a first sequence for the one or more LTFs; and
apply the first sequence to the one or more TRN fields for a single transmit chain, wherein each TRN subfield of the one or more TRN fields includes the first sequence.

22. The apparatus of claim 16, wherein the first non-legacy SIG field comprises an indication that the second non-legacy SIG field is present, and the second non-legacy SIG field carries signaling information corresponding to the U-SIG field, the first non-legacy SIG field, or both.

23. The apparatus of claim 16, wherein the second non-legacy SIG field comprises a buffer symbol satisfying a time duration threshold for receiver processing.

24. The apparatus of claim 16, wherein the U-SIG field comprises one or more of one or more version independent fields, one or more version dependent fields, and at least one of the U-SIG field, the first non-legacy SIG field, or the second non-legacy SIG field comprises data demodulation information, beamforming information, or both.

25. An apparatus, comprising:
a processing system that includes processor circuitry and memory circuitry that stores code, the processing system configured to cause the apparatus to:
receive a physical layer protocol data unit (PPDU) that includes:
a preamble that include a first segment and a second segment, the first segment comprising one or more initial training fields, a universal signal (U-SIG) field, and a first non-legacy signal (SIG) field, the U-SIG field immediately following the one or more initial training fields, the second segment comprising one or more short training fields (STFs), one or more long training fields (LTFs), or both, the U-SIG field indicating a PPDU type of the PPDU, and wherein the first non-legacy SIG field comprises a set of parameters that corresponds to the PPDU type.

26. The apparatus of claim 25, wherein the PPDU type comprises a regular data PPDU type, the PPDU comprising a data field in accordance with a data PPDU type, and wherein the set of parameters are indicated via a common field and a demodulation related field,
wherein the common field indicates one or more of a station identifier, a cyclic redundancy check, a tail, a PE or TRN switch indicator, or a short interframe response field, and
wherein the demodulation related field indicates one or more of a guard interval and LTF field, an indication of a quantity of LTF symbols, an indication of whether a second non-legacy SIG field is present within the second segment, a beamformed indication, a modulation and coding scheme field, a quantity of spatial streams, a low density parity check extra symbol segment, an indicator of low density parity check with a doubled code length, an unequal modulation indicator for a plurality of spatial streams, an additional modulation and coding scheme field for a plurality of spatial streams, or an interference mitigation indicator.

27. The apparatus of claim 25, wherein the PPDU type corresponds to data transmission and beam refinement procedure (BRP), the PPDU comprising a data field in accordance with the PPDU type corresponding to the data transmission and the BRP, and wherein the set of parameters are indicated via a common field, a demodulation related field, and one or more BRP beam training related fields,
wherein the common field indicates one or more of a station identifier, a cyclic redundancy check, a tail, a PE or TRN switch indicator, or a short interframe response field,
wherein the demodulation related field indicates one or more of a guard interval and LTF field, an indication of a quantity of LTF symbols, an indication of whether a second non-legacy SIG field is present within the second segment, a beamformed indication, a modulation and coding scheme field, a quantity of spatial streams, a low density parity check extra symbol segment, an indicator of low density parity check with a doubled code length, an unequal modulation indicator for a plurality of spatial streams, an additional modulation and coding scheme field for a plurality of spatial streams, or an interference mitigation indicator, and
wherein the one or more BRP beam training related fields indicate one or more of a training direction, a beam tracking request, a beam tracking request type, a quantity of transmit chains, a training length, a reception TRN-units per transmit TRN-unit, a TRN-unit P value, a TRN-unit M value, a TRN-unit N value, a TRN subfield sequence length, or a reception pattern in BRP transmission.

28. The apparatus of claim 25, wherein the PPDU type comprises a beam refinement procedure (BRP) PPDU type, and wherein the set of parameters are indicated via a common field and one or more BRP beam training related fields,
wherein the common field indicates one or more of a station identifier, a cyclic redundancy check, a tail, a PE or TRN switch indicator, or a short interframe response field, and
wherein the one or more BRP beam training related fields indicate one or more of a training direction, a beam tracking request, a beam tracking request type, a dual polarization TRN training indicator, a training length, a receiver TRN-units for each transmitter TRN-unit, a TRN-unit P value, a TRN-unit M value, a TRN-unit N value, a TRN subfield sequence length, or a reception pattern in BRP transmission.

29. A method for wireless communications, comprising:
transmitting a physical layer protocol data unit (PPDU) that includes:
a preamble that includes a first segment and a second segment, the first segment comprising one or more initial training fields, a universal signal (U-SIG) field, and a first non-legacy signal (SIG) field, the U-SIG field immediately following the one or more initial training fields, the second segment comprising one or more short training fields (STFs), one or more long training fields (LTFs), or both, the U-SIG field indicating a PPDU type of the PPDU, and wherein the first non-legacy SIG field comprises a set of parameters that corresponds to the PPDU type.

30. A method for wireless communications, comprising:
receiving a physical layer protocol data unit (PPDU) that includes:
a preamble that includes a first segment and a second segment, the first segment comprising one or more initial training fields, a universal signal (U-SIG) field, and a first non-legacy signal (SIG) field, the U-SIG field immediately following the one or more initial training fields, the second segment comprising one or more short training fields (STFs), one or more long training fields (LTFs), or both, the U-SIG field indicating a PPDU type of the PPDU, and wherein the first non-legacy SIG field comprises a set of parameters that corresponds to the PPDU type.
